(19) United States
(12) Patent Application Publication
(10) Pub. No.: US 2025/0387852 A1
(43) Pub. Date: Dec. 25, 2025

(54) Solar On-Orbit Welder for Assembly, Repair, and Manufacturing

(71) Applicant: Blueshift, LLC dba Outward Technologies, Broomfield, CO (US)

(72) Inventors: Andrew Timon Brewer, Arvada, CO (US); Troy Southard, Broomfield, CO (US); Alan Thomas Carter, Arvada, CO (US); Ryan Garvey, Lafayette, CO (US)

(73) Assignee: Blueshift, LLC dba Outward Technologies, Broomfield, CO (US)

(21) Appl. No.: 19/211,191

(22) Filed: May 18, 2025

Related U.S. Application Data
(60) Provisional application No. 63/661,623, filed on Jun. 19, 2024.

(51) Int. Cl. B23K 26/06; B23K 26/046; B23K 26/14; B23K 26/21; B64G 4/00

(52) U.S. Cl. CPC B23K 26/0648; B23K 26/046; B23K 26/0643; B23K 26/14; B23K 26/21; B64G 4/00

(57) ABSTRACT

A welding system and method of use, in particular a welding system that performs welding in the vacuum environment of space using concentrated solar energy. The system produces concentrated solar energy through a set of optical elements. A set of weld control elements including a focal distance actuator, an iris shutter, and a weld reflector produce a welding energy beam from the concentrated solar energy, the welding energy beam of selectable energy density and spot size and directed at an irradiation zone of a work piece wherein a weld is formed. A work piece end effector positions the work piece relative to the irradiation zone.

### CROSS REFERENCE TO RELATED APPLICATION

This application is a nonprovisional patent application of and claims the benefit of U.S. Provisional Patent Application No. 63/661,623 titled “Solar On-Orbit Welder for Assembly, Repair, and Manufacturing” filed Jun. 19, 2024, the disclosure of which is hereby incorporated herein by reference in entirety for all purposes.

### STATEMENT

This invention was made with government support under Contract Nos. 80NSSC23CA077 and 80NSSC22PA968, each awarded by the National Aeronautics and Space Administration (NASA). The government has certain rights in the invention.

### FIELD

The disclosure relates generally to a welding system and method of use, in particular to a welding system that performs welding in the vacuum environment of space using concentrated solar energy and specialized optical and weld control components.

### BACKGROUND

The development of in-space welding technologies has been a topic of interest to NASA since the early 1970s as a concept for joining and repairing large structures in space. In the late 1990s, NASA partnered with former Soviet states to produce the International Space Welding Experiment (ISWE) which was a modification of the Universal Hand Tool (UHT), an electron beam welder developed by the Russians and first used in space in 1984. The ISWE was tested terrestrially on aluminum, stainless steel, and titanium but the payload was cancelled before flight. Currently, a new version of the UHT known as the New Electron Beam Gun has been developed that has reduced the weight of the UHT from 20 kg to 1.8 kg and is able to weld materials greater than 1 mm thick thanks to its increased power of 2.5 kW; however, this system has not been tested in microgravity. As part of the ISAM initiative, in 2019, NASA awarded Made in Space a Phase I SBIR to develop a Mobile End-Effector Laser Device (MELD) to perform on-site, on-demand joining and repair of space structures. Busek Co. Inc. was also awarded a Phase I SBIR to develop a semiautonomous, teleoperated welding robot (using an undecided welding technique) for joining metals in space. The main drawbacks in these systems that will be addressed with the welding system of the disclosure (the “SO-WARM” system) include immense electrical power required for welding, excessive launch resources, and limited material and material thickness applicability.

Welding testbeds are an important part of process characterization, and current testbed technology enables the advancement of new welding processes, ideas, and applications. Discussion of these testbeds elucidates the functions of the SO-WARM system. Testbeds are used in the welding industry mainly to validate standards and increase the use of automated welding technologies that make the process more efficient, improve quality, and reduce costs for manufacturers. The National Institute of Standards and Technology (NIST) developed the Automated Welding Manufacturing System (AWMS) in 1997 with the goal of validating and testing standards, creating an open-source architecture by integrating new hardware and software concepts, and developing advanced welding technologies. Since then, automated welding testbeds have rapidly improved thanks to the advancement of machine learning and image processing algorithms that enable real-time data processing of welds and advanced post-processing of finished welds. A recent review of intelligent welding systems investigated the SOA of intelligent welding systems and the most important aspects of an automated testbed. They concluded that all intelligent welding system frameworks regardless of the welding process share these intelligence aspects: Monitoring (what is happening or has happened), diagnosis and understanding (what are the mechanisms), evaluation and prediction (where is the system, where is it going), and control (should the system state change and how). In terms of process monitoring, Hamzeh et al. claims there are three levels of weld process monitoring. The first level includes the parameters of the welding device itself (arc voltage, welding current, shielding gas flow, and wire feed speed). The second level of monitoring involves the welding conditions (weld seam and joint groove geometry). The third level relates to the sensor data acquisition during the weld process (temperature field and welding pool surface.

In this disclosure, the first level parameters get reduced to incoming irradiance, shutter position, welding control subsystems actuation, and translation speed while the second and third levels remain the same. Here, the disclosure is utilizing the ideas from these studies and Commercial Off-the-Shelf (COTS) hardware for an in-space welding system with a focus on weld process monitoring and weld characterization using sensors.

CSE has been applied experimentally to high temperature applications such as welding of metals, large-scale power generation by heating a receiver tower containing molten salts, and high temperature materials processing including surface hardening of steels, surface melting of grey cast iron for greater resistance to wear, cladding of stainless steel, and sintering of metallic powders for consolidation of “green parts”. CSE has been shown to be effective at providing sufficient power to weld high melting point materials such as H13 steel and AISI 316L stainless steel with a 2 kW parabolic concentrator at the PROMES-CNRS Odeillo furnace in France in ideal solar conditions on earth (1,000 W/m²) as well as 6082 Aluminum alloy at the Plataforma Solar de Almeria (PSA) in Spain. With a maximum flux of 7,000 kW/m² and spot size at the working surface of 12 cm, they achieved a microhardness that was 23% less than the parent material, which is comparable to other welding methods.

Solar concentrators have also been a topic of interest to NASA due to their ability to deliver high amounts of energy to a working surface for a variety of In Situ Resource Utilization (ISRU) applications such as regolith sintering, additive manufacturing, volatile extraction from regolith and biomass for fuel. Physical Sciences Inc. (PSI) developed a Solar Energy Module (SEM) that utilizes a series of parabolic mirrors to focus light into fiber optic bundles for CSE delivery through a quartz rod end effector. The primary benefit to PSI's SEM is the freedom to deliver CSE to any point at any orientation independent of the concentrating optics. The downfall of PSI's module is its low 33% optical efficiency, its mass and complexity, its lack of temperature control, and its susceptibility to overheating the end effector, making it unsuitable for in-space solar welding applications.

Structure-property relationships control the properties of metallic materials and the ability to weld those materials. While processes which develop reliable welds are known in a terrestrial environment, heat transfer mechanisms in space vary significantly from those present on Earth. Significantly more heat is lost from radiation while convective heat transfer is completely absent, and conductive heat transfer through the substrate will depend heavily on weld joint configuration. As a result of these different heat transfer mechanisms, the disclosure has developed novel solutions to reliably control the heat into, retained, and leaving welds produced on a variety of aerospace materials, and the heat flow within and around the weld is controlled to establish desirable microstructures and properties in a joint.

The disclosed welding system, the Solar On-Orbit Welder for Assembly, Repair, and Manufacturing (SO-WARM), consists of a primary solar concentrator, redirecting mirrors, a robotic end effector for part manipulation and structure traversing, three weld control subsystems, a wire/rod feeder for introducing filler material into the weld, an optional secondary solar concentrator, and both contact and non-contact process monitoring sensors for feedback control of the welding process based on multiple weld properties including weld temperature, weld spot size, radiative heat loss, conductive heat loss, and heat affected zone. This combined system enables the welding and joining of metals and non-metal materials using a solar-thermal power source and provides a system that controls the time-temperature of a weld. The system can achieve max temperatures of 2,300 C at the heated target and precision control of these temperatures to within +/−1% for long durations. This novel technology enables the welding and joining of metals and non-metal materials in space with a significant reduction in electrical power requirements compared to current state-of-the-art welding technologies. These capabilities come in a lightweight and durable design, keeping sensitive optics at a distance from the heated target to prevent them from fouling or overheating. SO-WARM enables the fabrication of large structures in space as well as servicing, repair, and disassembly of space structures.

The SO-WARM system utilizes Concentrated Solar Energy (CSE) as the primary heat source for welding and joining materials in space. SO-WARM may be used to assemble structures in space, thereby enabling the fabrication of crewed habitats, space telescopes, antennas, and solar array reflectors which are not possible with current technology due to their large size or due to their designs being unable to withstand vibrational loads during launch. Repair of these structures also becomes possible with SO-WARM to mitigate potential damage to structures caused from micrometeorites or orbital debris. Satellites may also be retrofitted, serviced, assembled, and repaired using the SO-WARM system and methods to extend service life of deployed satellites and reduce overall cost of new satellites. Disassembly of structures in space also becomes possible through solar-thermal melting and vaporization of metals and non-metal materials up to 2,300 C. These enabling capabilities are made possible through a lightweight, versatile design with significantly reduced electrical power requirements as compared to electron beam, electric arc, or laser power sources. SO-WARM relies on direct solar-thermal heating of materials to weld metals including titanium and aluminum, and join non-metal materials such as PEEK thermoplastic.

Benefits of the SO-WARM system include a significant reduction in electrical power demand, a reduced launch mass, and the ability to weld a variety of materials and thicknesses. By directly using CSE, the system reduces electrical power demands by at least 2.5 kW when compared to other space rated electrical arc welding systems like Rocketdyne's space rated GTAW welding system (See J. K. Watson and G. D. Schmittgrun, “Extra-Vehicular Activity Welding Experiment.” 21 Aug. 1989), and up to 17 kW power compared to terrestrial laser welding systems (See G. C. Rodrigues, M. Cuypers, E. F. Sichani, K. Kellens, and J. R. Duflou, “Laser cutting with direct diode laser,” Physics Procedia, vol. 41, pp. 558-565, 2013). The SO-WARM system minimizes launch mass by using a lightweight deployable design and eliminates many of the power management equipment required by other welding processes. Finally, the system protects electrical components by utilizing a radiation-based welding process rather than an electrical current while also enabling the joining of non-conductive materials such as thermoplastics and ceramics.

### SUMMARY

In one embodiment, a welding system is disclosed, the system comprising: a set of optical elements configured to receive an input light pattern and provide concentrated solar energy (CSE); a set of weld control elements configured to receive the CSE and provide a welding energy beam, the set of weld control elements comprising a focal distance actuator, an iris shutter, and a weld reflector; a weld feeder configured to deliver weld material to a welding site on a work piece; a work piece end effector configured to position the work piece relative to the welding site; and a system controller configured to control a set of welding parameters of the welding energy beam and to control a relative position of the work piece and the welding site by way of the work piece end effector; wherein: the focal distance actuator receives the CSE and provides a first energy beam of a selectable energy density controlled by the system controller; the iris shutter receives the first energy beam and provides the welding energy beam having a selectable spot size controlled by the system controller; the welding energy beam passes into an interior of the weld reflector and engages with the weld material at the welding site to create an irradiation zone that forms a weld on the work piece; and the weld reflector at least partially encloses the irradiation zone to reduce energy losses of the irradiation zone, the energy losses comprising at least one of radiation energy losses and reflection energy losses.

In one aspect, the set of optical elements include at least one of a parabolic reflector and a Fresnel lens, and at least two reflecting mirrors. In another aspect, the set of weld control elements further comprise a heat sink configured to conduct heat away from, and to dissipate heat of, the work piece. In another aspect, the set of weld control elements further comprise a mechanical agitator configured to perform at least one of scraping, scratching, grinding, discoloring, and vibrating a surface of the work piece. In another aspect, the set of welding parameters comprise weld temperature, weld spot size, radiative heat loss, conductive heat loss, and heat affected zone size. In another aspect, the system is configured to operate in a vacuum environment, and the irradiation zone forming the weld on the work piece is a vacuum irradiation zone.

In another aspect, the weld reflector comprises a retractable component configured to adjustably set an enclosure level by the weld reflector of the irradiation zone. In another aspect, the weld reflector is of hemispherical shape and the enclosure level is selectable between a full enclosure state and a set of partially enclosed states. In another aspect, the welding system further comprises a set of sensors configured to identify a work piece phase change, the work piece phase change used by the controller to control the set of weld parameters. In another aspect, the welding system further comprises an air curtain device configured to deliver a sweeping gas adjacent to the iris shutter to reduce fouling of the iris shutter.

In another embodiment, a method of using a welding system is disclosed, the method comprising: providing a welding system comprising: a set of optical elements configured to receive an input light pattern and provide concentrated solar energy (CSE); a set of weld control elements comprising a focal distance actuator, an iris shutter, and a weld reflector; a weld feeder configured to deliver weld material to a welding site on a work piece; a work piece end effector configured to position the work piece relative to the welding site; and a system controller configured to control a set of welding parameters of the welding beam and to control a relative position of the work piece and the welding site by way of the work piece end effector; positioning the work piece in preparation for receiving a weld; positioning the focal distance actuator to receive the CSE and provide a first energy beam of a selectable energy density; positioning the iris shutter to receive the first energy beam and provide a welding energy beam having a selectable spot size; passing the welding energy beam into an interior of the weld reflector and engaging with the weld material at the welding site to create an irradiation zone that forms the weld on the work piece; and adjustably enclosing the irradiation zone with the weld reflector to reduce energy losses of the irradiation zone, the energy losses comprising at least one of radiation energy losses and reflection energy losses.

In one aspect, the set of optical elements include at least one of a parabolic reflector and a Fresnel lens, and at least two reflecting mirrors. In another aspect, the set of weld control elements further comprise a heat sink configured to conduct heat away from, and/or to dissipate heat of, the work piece. In another aspect, the set of weld control elements further comprise a mechanical agitator configured to perform at least one of scraping, scratching, grinding, discoloring, and vibrating a surface of the work piece. In another aspect, the set of welding parameters comprise weld temperature, weld spot size, radiative heat loss, conductive heat loss, and heat affected zone size. In another aspect, the system is configured to operate in a vacuum environment, and the irradiation zone forming the weld on the work piece is a vacuum irradiation zone. In another aspect, the weld reflector comprises a retractable component configured to adjustably set an enclosure level by the weld reflector of the irradiation zone.

In yet another embodiment, a welding system is disclosed, the system comprising: a set of optical elements configured to receive an input light pattern and provide concentrated solar energy (CSE); a set of weld control elements configured to receive the CSE and provide a welding energy beam, the set of weld control elements comprising a focal distance actuator, an iris shutter, and a weld reflector comprising a retractable component; a weld feeder configured to deliver weld material to a welding site on a work piece; a work piece end effector configured to position the work piece relative to the welding site; a set of sensors configured to identify any work piece phase change; and a system controller configured to control a set of welding parameters of the welding energy beam and to control a relative position of the work piece and the welding site by way of the work piece end effector; wherein: the focal distance actuator receives the CSE and provides a first energy beam of a selectable energy density controlled by the system controller; the iris shutter receives the first energy beam and produces the welding energy beam having a selectable spot size controlled by the system controller; the welding energy beam passes into an interior of the weld reflector and engages with the weld material at the welding site to create an irradiation zone that forms a weld on the work piece; the retractable component adjustably sets an enclosure level by the weld reflector of the irradiation zone to reduce energy losses of the irradiation zone, the energy losses comprising at least one of radiation energy losses and reflection energy losses; any identified work piece phase change is used by the controller to control the set of weld parameters; and the set of welding parameters comprise at least two of weld temperature, weld spot size, radiative heat loss, conductive heat loss, and heat affected zone size.

In one aspect, the weld reflector is of hemispherical shape and the enclosure level is selectable between a full enclosure state and a set of partially enclosed states.

By way of providing additional background, context, and to further satisfy the written description requirements of 35 U.S.C. § 112, the following set of references are incorporated by reference in entirety for all purposes: U.S. Pat. No. 11,162,713 issued Nov. 2, 2021 to Garvey et al; US Patent Application Publication Nos. 2022/0274077 published Sep. 1, 2022 to Brewer et al (“SCORCHER”); 2022/0268488 published Aug. 25, 2022 to Brewer et al (“SCORCHER+”); 2023/0152008 published May 18, 2023 to Brewer et al (“SEER”); U.S. Pat Appl No. 63/526,914 filed Jul. 14, 2023 to Garvey et al (“LAMA”); and Ser. No. 18/644,000 filed Apr. 23, 2024 to Garvey et al (“T-LAMA”).

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The disclosed methods and/or systems may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

Various embodiments may also or alternatively be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The disclosure will be readily understood by the following detailed description in conjunction with the accompanying drawings, wherein like reference numerals designate like elements. The elements of the drawings are not necessarily to scale relative to each other. Identical reference numerals have been used, where possible, to designate identical features that are common to the figures.

FIG. 1A is a schematic representation of one embodiment of a welding system;

FIG. 1B is a schematic representation of another embodiment of a welding system;

FIG. 2 is a more detailed schematic representation of the welding system embodiment of FIG. 1A;

FIG. 3 is another more detailed schematic representation of the welding system embodiment of FIG. 1A;

FIG. 4A depicts a front view of another embodiment of a welding system;

FIG. 4B depicts a side view of the welding system embodiment of FIG. 4A;

FIG. 5 is a flow chart of a method of use of the welding system of FIG. 3;

FIG. 6A depicts another embodiment of a welding system operating on a habitation module work piece;

FIG. 6B depicts another embodiment of a welding system operating on a habitation module work piece;

FIG. 6C depicts another embodiment of a welding system operating on a habitation module work piece;

FIG. 7A depicts a top view of weld control elements of a welding system;

FIG. 7B depicts a side view of the weld control elements of FIG. 7A;

FIG. 7C depicts a perspective view of the weld control elements of FIG. 7A;

FIG. 8A depicts a perspective view of weld control elements and a grasping end effector of a welding system;

FIG. 8B depicts a side view of the weld control elements and grasping end effector of FIG. 8A;

FIG. 8C depicts a perspective view of an air curtain element of a welding system;

FIG. 9A1 depicts a first operating mode of one embodiment of a weld reflector element of a welding system;

FIG. 9A2 depicts a second operating mode of the embodiment of a weld reflector element of FIG. 9A1;

FIG. 9A3 depicts a third operating mode of the embodiment of a weld reflector element of FIG. 9A1;

FIG. 9B depicts operating modes and details of another embodiment of a weld reflector element of a welding system;

FIG. 9C depicts operating characteristics of a weld reflector system operating in a first mode;

FIG. 9D depicts operating characteristics of a weld reflector system similar to that of FIG. 9C operating in a second mode;

FIG. 10A depicts yet another embodiment of a welding system operating on a habitation module work piece;

FIG. 10B depicts the embodiment of a welding system of FIG. 10A operating on a diamond-shaped work piece; and

FIG. 11 depicts another embodiment of a welding system operating on a habitation module work piece.

It should be understood that the proportions and dimensions (either relative or absolute) of the various features and elements (and collections and groupings thereof) and the boundaries, separations, and positional relationships presented there between, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments. The following descriptions are not intended to limit the embodiments to one preferred embodiment. To the contrary, it is intended to cover alternatives, modifications, and equivalents as can be included within the spirit and scope of the described embodiments as defined, for example, by the appended claims.

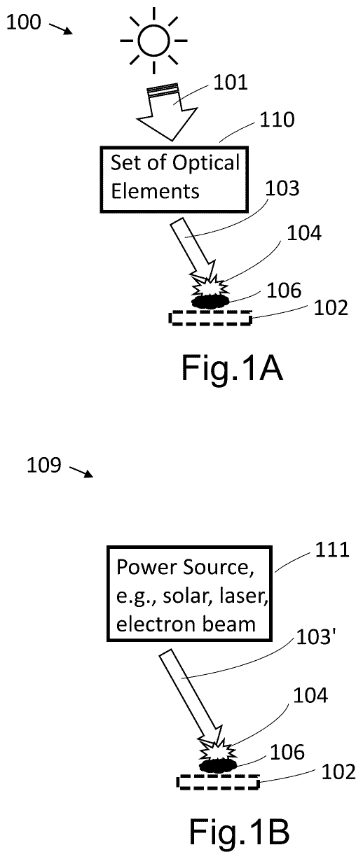

The disclosed devices, systems, and methods of use will be described with reference to FIGS. 1-11. Generally, systems and methods to provide a welding system and method of use are provided. The term “system” or “SO-WARM” may be used to refer to an embodiment of the welding system. The term “method” may be used to describe an embodiment of a method of use of the welding system.

The SO-WARM system is the first demonstrated CSE welding system incorporating a Fresnel refractive primary concentrating optic, making it suitable for use in space. The innovative system is capable of welding metallic and non-metallic materials and has significantly lower electrical power requirements than other State of the Art (SOA) in-space welding technologies. The concept has been proven to form strong, low porosity fusion welds on aluminum and titanium with thicknesses ranging from 1 mm to 6.35 mm. The joining of thermoplastics has also been demonstrated.

The disclosure is intended to supplant other SOA ISAM welding processes by providing a technology that requires very minimal electrical power and leverages SOA weld process monitoring tools for continuous autonomous operation and qualification of structures produced. The system generates the required power density for welding high temperature materials with CSE using concentrating optics as small as 1.5 m² in area in one embodiment and as small as 1.2 m² in another embodiment (these values are a function of, e.g., the material and the material thickness), weighing about 3.5 kg for the space-deployable system. The system forms a controllable melt pool in both metallic and/or non-metallic polymer materials. More generally, in some embodiments, for example, the melt pool may include one or more of glass, regolith, metals, non-metals, and polymer materials. This solar welding system is a novel technology that provides the ability to reliably and consistently join materials in space. As part of the ISAM architecture, SO-WARM enables the construction of large space structures in-space and reduces the constraints on space systems imposed by launch vehicles and the rocket equation. SOA weld process monitoring tools such as contactless temperature monitoring and computer vision work well with the technology for in-situ process monitoring and autonomous operation. The direct use of solar energy for in-space fusion joining will revolutionize in-space manufacturing by using solar thermal energy directly to form fusion joints, eliminating costly energy conversion losses common to electricity-based heat generation and welding systems.

SO-WARM is able to weld both large structures and small components for space-system repair and new construction applications. During large scale construction, SO-WARM may move about the next generation of space stations, large satellites, or truss assemblies and autonomously weld surfaces and components together. At smaller scales, the SO-WARM system can orient itself for maximum efficiency and act as a welding station with part manipulation. Additionally, scenarios requiring higher energy densities than produced by the primary concentrator will also be possible with the use of a Supplemental Solar Concentrator. SO-WARM is an essential complementary technology to in-space assembly, repair, and manufacturing techniques and will provide a cost-effective alternative to SOA in-space welding tools.

Generally, a welding system that performs welding in the vacuum environment of space using concentrated solar energy is disclosed. The system produces concentrated solar energy through a set of optical elements. A set of weld control elements including a focal distance actuator, an iris shutter, and a weld reflector produce a welding energy beam from the concentrated solar energy, the welding energy beam of selectable energy density and spot size and directed at an irradiation zone of a work piece wherein a weld is formed. A work piece end effector positions the work piece relative to the irradiation zone.

Welding system elements for increasing control and versatility of the SO-WARM system include: 1) grasping end effector for manipulating the workpiece being welded or for moving the solar welding system about the workpiece/structure; 2) a focal distance actuator for controlling concentrated solar energy density, 3) a mechanical iris shutter for metering light from the solar concentrator system and controlling the size of the transmitted CSE spot; 4) an adjustable weld reflector surrounding the irradiation zone which is constructed of overlapping petals to control energy losses to space through radiation and reflection; 5) a position-adjustable heat sink for conducting heat from the workpiece and dissipating this heat via a radiator, thereby reducing the width of the heat affected zone and limiting the temperature rise of nearby material; 6) a wire or rod feeder for controlling feed of filler material into the weld; and 7) a mechanical agitator that scrapes/scratches/is vibrated across the heated material in the case of welding aluminum to break apart the outer oxide layer and expose the now lower melting temperature aluminum underneath. A colorant may also be applied to the surface of the material to be welded to increase solar absorptivity. A grinder may optionally be included to remove the oxidation layer while in the vacuum of space and to “roughen” the weld surface to increase its solar absorptivity.

Effectively, these subsystems provide four different modes of temperature control for the weld: 1) controlling the weld speed with the robotic manipulator, 2) controlling the amount of CSE delivered to the weld with through focal distancing and iris spot size control, 3) controlling radiative heat loss with the weld reflector, and 4) controlling conductive heat loss with the heat sink. Additionally, the wire/rod feeder controls speed of introducing filler material into the weld while the agitator, colorant, and/or grinder assists in welding materials which have a higher temperature oxides layer potentially coating the material's surface. Temperature, process, and state monitoring sensors assist these coordinated processes.

Although the disclosed devices, systems, and methods of use will be principally described relative to a welding system in space (or other vacuum conditions) as enabled by solar energy, the devices, systems, and methods of use have other applications. For example, the method and/or devices may be used in terrestrial applications and/or may be enabled by other power sources such as lasers or electron beams. Other applications or uses are possible.

The phrase “light pattern” refers to all characteristics of an emitted light/source of photons/electromagnetic radiation, such as brightness, profile angle, color, pixilation, etc. The phrase “light profile” refers to the angle of the emitted cone of light; light profile is one characteristic of a light pattern.

With attention to FIGS. 1A-B, respective embodiments of a welding system 100 and 109 are described. The two embodiments are similar in that a power source is used to create a thermal reaction or welding reaction at an irradiation zone to produce a weld on a work piece 102. In the embodiment of FIG. 1A, welding system 100 receives solar energy 101 from the sun and through a set of optical elements 110 produces concentrated solar energy (CSE) directed to an irradiation zone. In contrast, the embodiment of FIG. 1B depicts a welding system 109 that produces a more generalized power source 111 (which may be the solar power source of system 100 but instead may be an alternate power source, such as laser, electron beam, etc. as known to those skilled in the art) to produce a power source emission 103′ directed to an irradiation zone, although some power sources may need more system adaptations than others. Although most of the description below of welding system embodiments are with respect to the solar power embodiments of system 100 and FIG. 1A, the welding system of the disclosure may instead be enabled by any power system such as shown in system 109 of FIG. 1B.

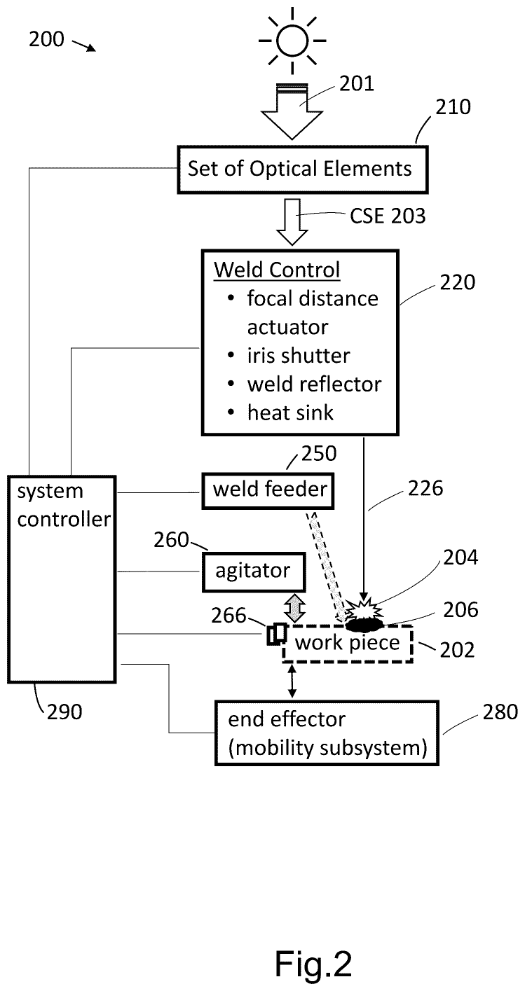

FIGS. 2-11 describe welding systems and associated components or operational aspects with similarities to those of system 100 of FIG. 1A.

Embodiments of a welding system enabled by solar power are depicted in FIGS. 2, 3, and 4A-B, each respective system 200, 300, and 400 generally first producing CSE through a set of optical elements, then tuning or optically changing the CSE through a set of weld control elements to produce a welding energy beam directed to a welding site where an irradiation zone is established on a work piece. Generally, each of the systems of the disclosure are configured to operate in a vacuum environment, and the irradiation zone forming the weld on the work piece is a vacuum irradiation zone.

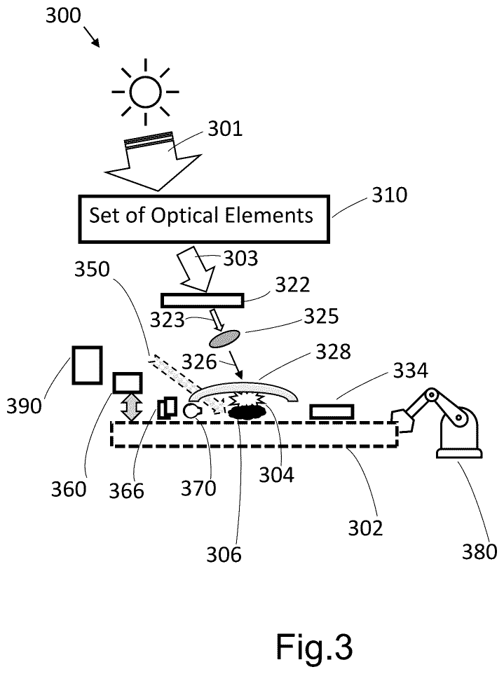

With attention to FIG. 2, a welding system 200 is described. Most generally, the welding system 200 operates on a work piece 202 and comprises a set of optical elements 210, a set of weld control elements 220, a weld feeder 250, an agitator 260, system sensors 266, end effector 280 aka mobility subsystem, and a system controller 290. The set of optical elements 210 receive an input light pattern 201 from the sun and produce CSE 203. The set of weld control elements 220 (described in more detail below, e.g. in FIG. 3) receive the CSE 203 and produce a welding energy beam 226 directed to welding site 206 within irradiation zone 204. The system controller 290 controls the set of optical elements 210, the weld control elements 220, the weld feeder 250, the agitator 260, the sensors 266, and the end effector 280.

The system controller 290 (and any reference to “system controller” throughout this disclosure) may include or be associated with a computer processor configured to perform, among other things, processing of received measurements, such processed measurements providing input, for example, to the controller to enable control functions of the controller, such as feedback control and the like as known to those skilled in the art.

The welding system 200 may be broken down into following subsystems: (1) primary solar concentrator and CSE delivery, (2) weld control, and (3) system mobility and part manipulation. Overall, the primary concentrator (or other optical element 210) collects incoming sunlight and concentrates it to a point at the focal length. One or more redirecting mirrors (or other optical elements 210) may be used before or after the primary concentrator to give the concentrator access to the entire workpiece. The tilting of the mirror (or other optical element 210) allows for precise manipulation of the concentrated hot spot position and use of the conventional weaving motions while forming a joint. The welding process is controlled with a retractable weld reflector to limit energy losses to space and a detachable radiative heat sink to promote heat loss and reduce the size of the heat affected zone (HAZ). Together, these two subsystems enable control over the weld and annealing process to minimize defects and produce strong welds in a variety of conditions in space. An iris shutter mechanism controls the concentrated spot size and therefore controls melt pool size. Coupled between focal distance of the solar concentration and delivery subsystem and weld control subsystems allows for precise temperature control. These CSE control mechanisms enable welding of lower temperature materials like thermoplastics and thinner materials that require minimal penetration depth.

In some embodiments, a Fresnel lens is used as an optical element 210. Fresnel lenses are best for solar thermal applications in space since they are thin (≤2 mm) planar optics that can be sectioned for array deployment and stowed flat, minimizing weight and launch volume. Also, they can potentially be designed to unroll for space deployment. The Fresnel lens concentrator has the most straightforward implementation because the concentrator transmits rather than reflects light and provides a direct path for the sunlight in all scenarios.

In some embodiments, a parabolic and/or spherical reflector is used as an optical element 210. An on-axis or an off-axis parabolic reflector can be used as a primary, secondary, or tertiary optical element within the set of optical elements 210. Parabolic reflectors may be composed of deployable thin films, a single rigid element, or an assembly of either rigid or thin-film reflective elements.

For temperature and spot size control, SO-WARM implements an iris shutter near the weld pool. The system is coupled with focal distancing of the concentrator relative to the working surface, and the two systems control thermal input into the weld. The iris shutter is positioned away from the focal point of the concentrator, and various low temperature materials are used. As the iris shutter closes, the total amount of energy passing through to the weld pool is restricted and the concentrated spot size is reduced. This gives ultimate control over the weld pool size but does not change the energy density within that spot. In order to control temperature for varying spot sizes, the solar concentration ratio must be manipulated by controlling the effective distance between the concentrator and the weld pool/working surface. It is important to note that the focal distancing mechanism must be used in conjunction with the iris shutter because as the concentrator moves closer to the working surface, the spot size increases, requiring the iris to maintain a desired spot size. A shutter system such as the louver system shown may be used in conjunction with orifice plates to control temperature and spot size during initial developmental and demonstration testing, providing temperature control to, in one embodiment, within +1% of the set temperature.

With attention to FIG. 3, a welding system 300 is described; the system 300 is very similar to that of system 200 but shows some additional detail and additional components. The welding system 300 operates on a work piece 302 and comprises a set of optical elements 310, a set of weld control elements, a weld feeder 350, an agitator 360, system sensors 366, air curtain 370, and end effector 380 aka mobility subsystem, and a system controller 390. The system controller 390 controls, among other things, a set of welding parameters of the welding energy beam 326 and controls a relative position of the work piece 302 and the welding site 306 by way of the work piece end effector 380. The system controller 390 may also provide feedback control of the feedback of the generated melt pool, as described below. The set of welding parameters controlled by the system controller 390 may include weld temperature, weld spot size, radiative heat loss, conductive heat loss, and/or heat affected zone size.

The weld feeder 350 delivers weld material to the welding site 306 on the work piece 302. The work piece end effector 380 positions the work piece relative to the welding site 302.

The set of optical elements 310 receive an input light pattern 301 from the sun, and produce CSE 303. The set of weld control elements receive the CSE 303 and produce a welding energy beam 326 directed to welding site 306 within irradiation aka reaction zone 304.

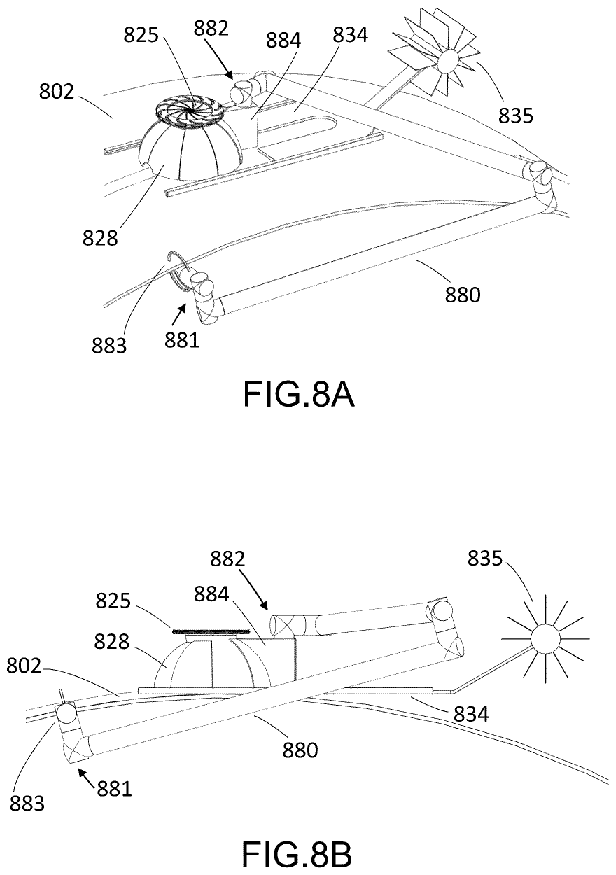

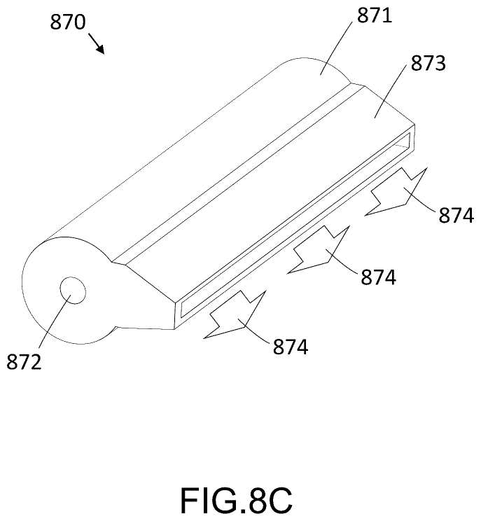

The air curtain 370 uses a nozzle and inert gas supply to prevent fouling optical components when operating in vacuum. The air curtain 370 generally flows a rarified, transition, or continuum gas across optics when operating in a vacuum to prevent the formation of fouling. See FIG. 8C for more description of the air curtain.

The set of weld control elements comprise a focal distance actuator 322, iris shutter 325, weld reflector 328, and heat sink 334. The focal distance actuator 322 receives the CSE 303 and produces a first energy beam 323 of a selectable energy density, the selectable energy density of the first energy beam 323 effected or controlled by the system controller 390. The iris shutter 325 receives the first energy beam 323 and produces a welding energy beam 326 having a selectable spot size, the selectable spot size effected or controlled by the system controller 390.

The welding energy beam 326 passes into an interior of the weld reflector 328 and engages with the weld material at the welding site 306 to create an irradiation zone 304 that forms a weld on the work piece 302. The weld reflector 328 surrounds the irradiation zone 304 to reduce and control energy losses of the irradiation zone 304, the energy losses comprising radiation energy losses and reflection energy losses.

The iris is a proven method of controlling the power into the focal position. In conjunction with focal distancing, the iris will be able to maintain constant spot sizes while power is adjusted, and the energy into the weld is controlled. To prevent damage, the iris is positioned away from the focal point of the solar concentrator, and the subsystem will not be subjected to the high energy densities experienced at the weld site. Consequently, lower temperature materials such as aluminum will be used for the iris hardware.

The weld reflector (to include the interior) forms a weld shield that is coated with a highly reflective surface and is comprised of several rotatable petals. Rotation of the petals of the reflector adjusts the radiative heat transfer from the weld to space. During conditions in which welds need to maintain temperature for annealing, stress relief, or other purposes; the leaves may be adjusted to reflect the majority of energy back to the weld.

The heat sink 334 conducts heat away from the work piece 302 and/or dissipates heat of the work piece 302. The adjustable heat sink 334 of the welding system 300 is a horseshoe shaped component attached to either a radiator, thermal mass, or other thermal control device. In other embodiments, the adjustable heat sink may take different shapes and be adjusted in different ways. For example, the width of the horseshoe may be variable to limit the heat affected zone and protect surrounding components attached to a habitat from overheating. In situations where rapid cooling of the weld bead is desired, the radiative heat sink is slid towards the weld. Thermal conduction transfers heat from the weld to the thermal control device which dissipates the heat. The amount of heat transferred from the weld to the thermal control device is controlled by the position of the horseshoe conductor.

The three subsystems (iris, weld reflector, heat sink) allow for precise control of the heat into, within, and out of the system and can prevent or encourage the loss of heat, and a highly controllable welding environment results from the cooperation of these systems.

The mechanical agitator 360 performs or imparts scraping, scratching, grinding, discoloring, and/or vibrating to a surface of the work piece 302.

The sensors 366 may include process monitoring sensors, such as: sun sensors, state and orientation monitoring of the welding system relative to the workpiece/structure, temperature measurement via contact or non-contact methods, optical sensors, and/or monitoring the melt pool for phase change and/or melt pool dynamics.

The system controller 390 may perform in-situ process monitoring and control by using non-contact temperature measurements and a high dynamic gain camera to monitor the welding process and direct welding control systems to maintain a consistent manufacturing process. The high dynamic gain camera is configured to see through the bright reflections of the solar welding process. The control system may additionally be integrated into any of several varied solar thermal processes which use concentrated solar energy to conduct high temperature processes, as known to those skilled in the art.

The system controller 390 may implement a combination of computer vision tools and contactless temperature measurements to identify the formation of a phase change in a material heated by concentrated solar energy. The process also uses computer vision tools and temperature indications to monitor the size and stability of manufacturing processes which includes a phase change. Generally, the system controller 390 may monitor the pixel intensities of various regions of the melt pool to determine the presence and size of the melt pool. As a melt pool forms, the average pixel intensity of the concentrated solar spot drops significantly due to the different optical properties of the molten and solid phases. In addition to the formation of a melt pool, the size of the melt pool may also be estimated by the high dynamic gain optical sensor. The system controller 390 may monitor and identify reductions in pixel intensity upon melt pool formation and also changes in the melt pool size as indicated by changes in the local minimum in pixel intensity. (While molten metals have lower reflectivity than the solid phase, the hotter portions of the melt pool emit more radiation which appears as a local maximum).

The system controller 390 thus may perform in-situ process control using a contactless temperature indication and a high dynamic gain optical sensor to monitor the welding process and inform the actuation of the weld control subsystems of the larger welding system.

Stated another way, the system controller 390 may provide an autonomous feedback and control system that provides bi-directional thermal control over the entire welding process to minimize defects and produce strong welds in a variety of conditions in space. The system controller 390 thus not only controls the heat affected zone (and thereby controlling surface temperature, melt pool geometry, and depth of penetration) but also controls the amount of vaporized gases or contaminants that occur during welding that could otherwise damage nearby sensors or surfaces.

The contactless temperature indication may monitor the electromagnetic emissions of the melt pool while the high dynamic gain optical sensor may monitor the optical properties of the process. These two indications may be used to identify the formation of a phase change from solid material to molten material to initiate the welding process. (In one embodiment, the solid material is a solid metal material, and the molten material is a molten metal material). Following the formation of a melt pool, the temperature indication and high dynamic gain optical sensor may monitor the temperature and size of the melt pool. A control code generated from these signals may be used to maintain a stable welding process by adjusting the welding speed along with the location of the adjustable weld reflector, adjustable weld heat sink, mechanical iris, and focal position of the SO-WARM system.

Because of the broad range of wavelengths included in the solar spectrum, a specific wavelength may be identified for the contactless temperature monitoring of the system. Additionally, this wavelength depends on other lens material selected for the welding system. In the case of a polycarbonate lens, a pyrometer monitoring wavelengths greater than 2 μm is able to accurately monitor the melt pool temperature. Since polycarbonate has a low transmissivity at these wavelengths, any radiation measured with these wavelengths will be due to melt pool emissions/temperature rather than melt pool reflections. These wavelengths may be adjusted depending on the lens material used by a particular SO-WARM embodiment.

The high dynamic gain optical sensor generates an image able to sees through the reflections taking place during a solar weld. Because molten melt has a higher absorptivity and a lower reflectivity than the sold phase, the melt pool formation is indicated by a lowering pixel intensity. As a result, an area of pixels with intermediate to low pixel intensity which was previously high pixel intensity indicates the formation of a melt pool. Using the average pixel intensities of different regions of the recoded image, the size of a melt pool generated by concentrated solar energy may be accurately measured. The rates of change may then be monitored to determine if more or less energy is required, which in-turn informs the actuation of the weld control subsystems of the welding system.

In one embodiment, a high-dynamic-range welding camera and a two-color pyrometer are integrated into the welding system to provide for process development and characterization. Controller and/or system processor software enables analysis of the camera data in real-time, extracting key parameters such as melt pool size, and utilizes pyrometer data for feedback control of weld speed, thereby enabling autonomous, closed-loop control of the welding process.

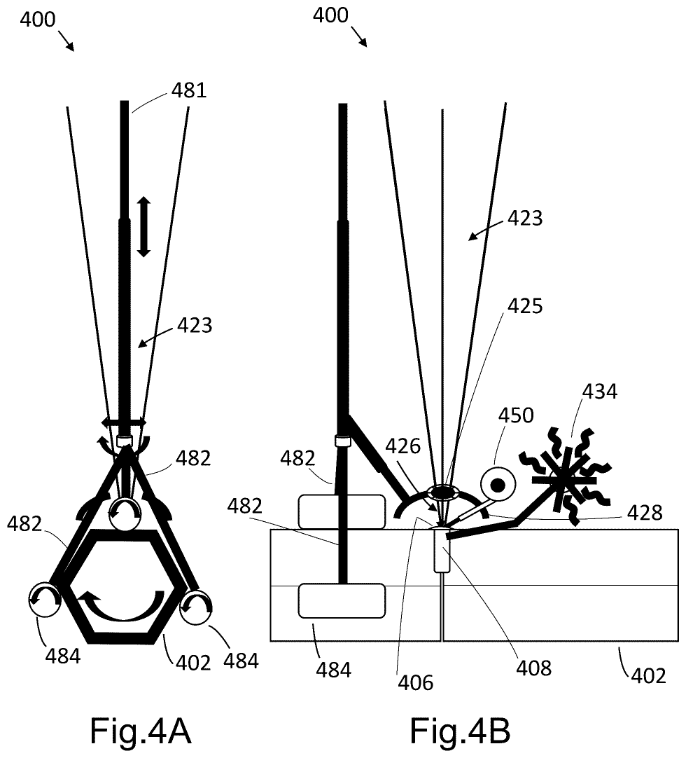

With attention to FIGS. 4A-B, a welding system 400 is described. FIG. 4A depicts an end view and FIG. 4B depicts a side view of system 400. Most generally, the welding system 400 operates on a work piece 402 (the work piece depicted is a structural truss member) and comprises iris shutter 425, weld feeder 450, heat sink 434, weld reflector 428, and end effector comprising clamping arms 482 with clamping rollers 484 and telescoping arm 481. The iris shutter 425 receives the first energy beam 423 and produces welding energy beam 426 directed to welding site 406 within an irradiation zone wherein a weld bead 408 is formed.

The adjustable weld reflector limits energy losses to space and maintains weld temperature as required. An adjustable radiative heat sink can promote heat loss when required and limit the heat affected zone size as needed. Energy into the system is controlled by an iris and focal distancing of the primary concentrator. An iris shutter mechanism controls the concentrated spot size and therefore the resulting melt pool size. Adjusting the distance between the primary concentrator and first redirecting mirror selectively focuses or defocuses the projected solar spot and changes the power density at the melt pool. Together, these three components may control the time-temperature curve of the weld while in the vacuum of space, minimize defects, and produce strong welds in a variety of conditions. Additionally, these CSE control mechanisms enable welding of lower temperature materials like thermoplastics and thinner materials that require minimal penetration depth.

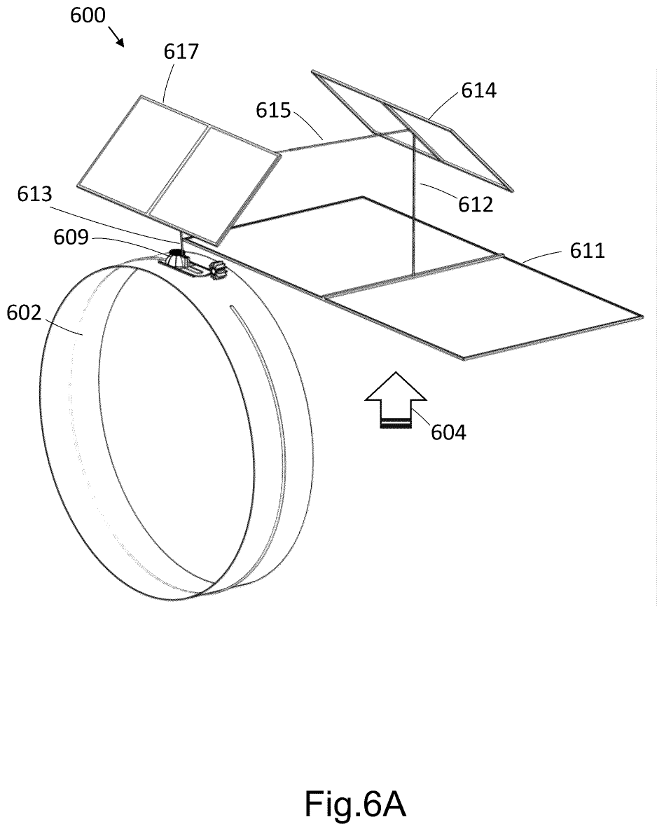

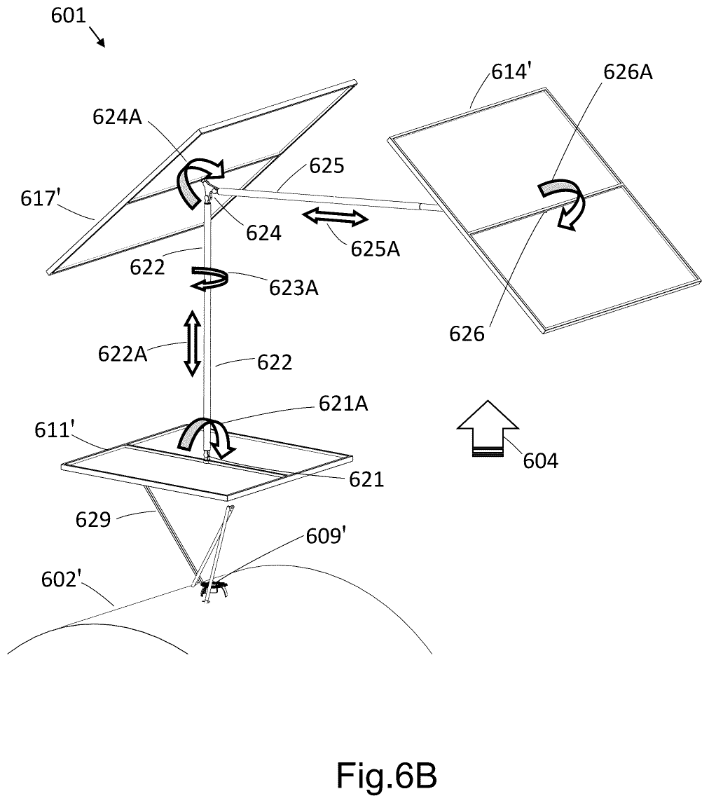

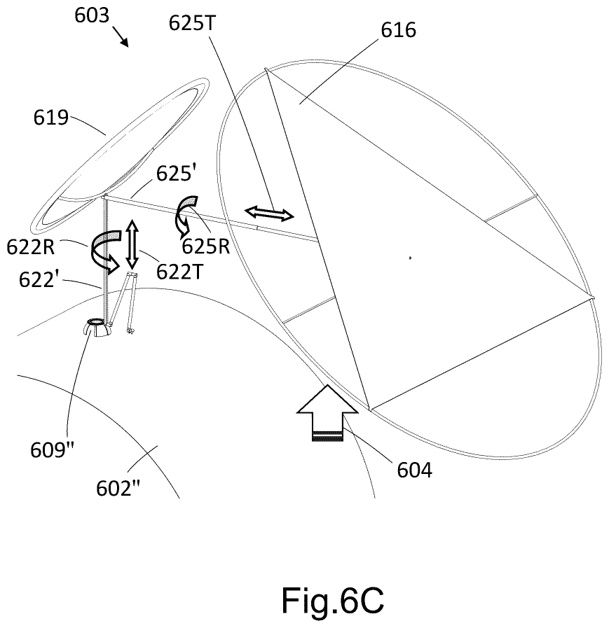

Note that a given welding system can either move around the part for surface operations on large modules/habitats (See, e.g., FIGS. 6A, 6B, 10A, and 11) or remain stationary while manipulating smaller workpieces like structural members (See, e.g., FIGS. 4A-B and 10B). In either scenario, relative motion between SO-WARM and the workpiece is achieved using a clamping roller system while a reaction wheel is used to offset moments generated through rotation of the part while joining material in a variety of assembly configurations ranging from butt, tee, corner, or edge welds.

The primary concentrator and redirecting mirror are mounted together and to the clamping roller system through robotic limbs that adjust the position and rotation of the concentrator and reflectors relative to each other and to the workpiece. The combined connections between the mobility system, primary concentrator, and redirecting mirrors may be maintained, for example, at 6 m in length which enables the welding on a (for example) 4.5 m diameter habitat. While these robotic limbs are long by Earth standards, the microgravity environment in orbit will greatly reduce the mass of material required to make these connections, since they only need to contend with the inertia of the concentrator and redirecting mirror. The robot limb system may have up to six or more total joints (not including the clamping roller system), each equipped with a single rotary and hinge joint so that the primary concentrator and redirecting mirrors may be positioned at a variety of angles and maximize access to the workpiece. Additionally, both limbs can telescope to allow further range of motion and focal distancing control.

The clamping roller system is used to attach to both large structures and smaller parts. An example baseline system is composed of three extendable arms with motorized rollers. In the case of smaller parts like truss members, the rollers are used to manipulate and rotate the part beneath the concentrator system so that a continuous weld bead can be formed on the part without moving the concentrator system. When gripping smaller components, two of the three rollers are used to “grab” the part, exploiting the diameter of the roller to clamp the part in place with a single articulation point. For welding on large structures like space station modules, the weld is translated across the surface by rotating the redirecting mirrors or translating the system and the rollers will be used only intermittently to reposition the welder periodically after large sections of welds are completed. SO-WARM may, in some embodiments, be equipped with reaction wheels or control moment gyroscopes (CMG) to prevent undesired movement of the concentrator relative to the workpiece and the sun.

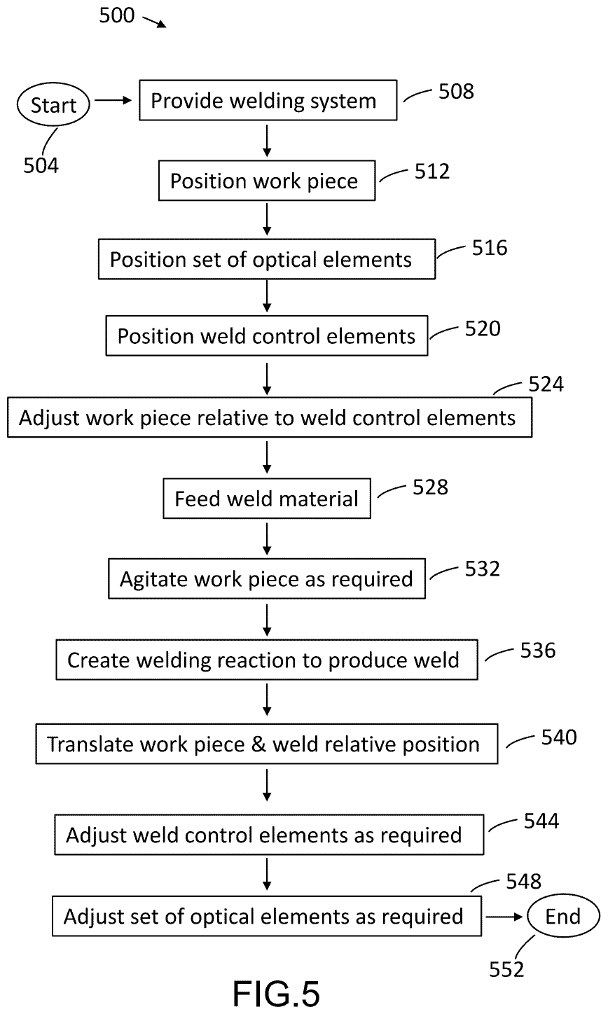

FIG. 5 is a flow chart of a method of use 500 of the welding system embodiments above in FIGS. 2, 3, and 4A-B. Note that some steps of the method 500 may be added, deleted, and/or combined. The steps are notionally followed in increasing numerical sequence, although, in some embodiments, some steps may be omitted, some steps added, and the steps may follow other than increasing numerical order. Any of the steps, functions, and operations discussed herein can be performed continuously and automatically. The method starts at step 504 and ends at step 552.

After starting at step 504, the method 500 proceeds to step 508. At step 508, a welding system is provided. The welding system may be any of the embodiments described herein or combinations thereof. After completing step 508, the method 500 proceeds to step 512.

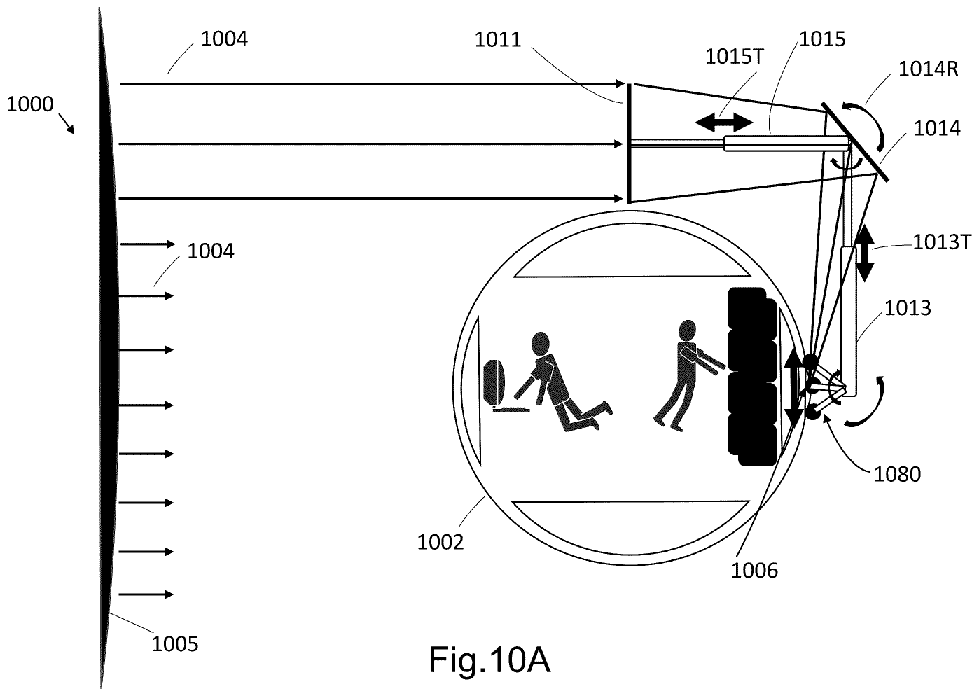

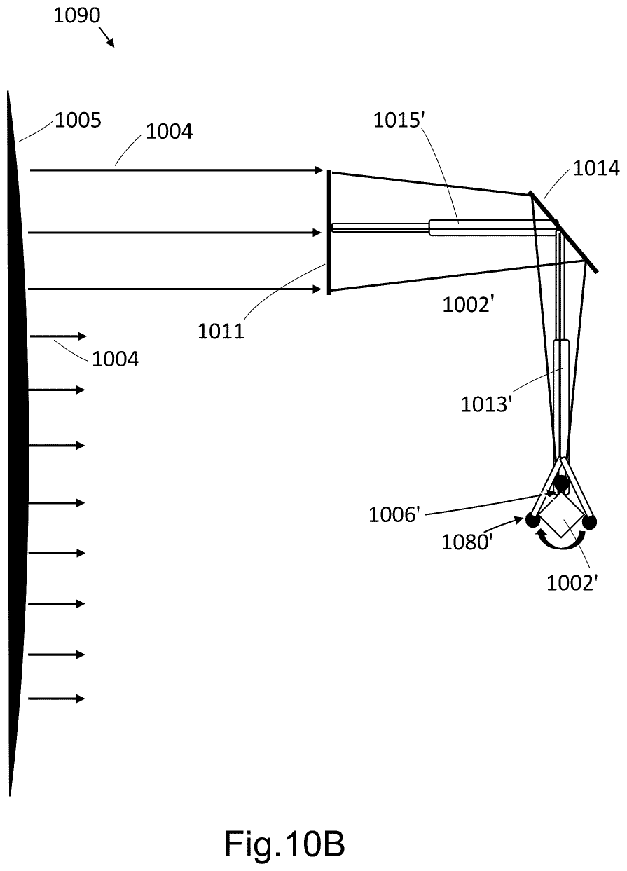

At step 512, the work piece to undergo welding is initially positioned for welding. The work piece may be a portion of a much larger structure, such as a space habitation module shown in FIG. 10A, or may be an isolated piece, such as that shown in any of FIGS. 1A, 1B, 2, and 3, for example. After completing step 512, the method 500 proceeds to step 516.

At step 516, the set of optical elements are positioned. The set of optical elements may include one or more of a Fresnel lens or a parabolic reflector and at least two reflecting mirrors, such as described in FIG. 6 below, and are controlled by the system controller. The set of optical elements receive and direct incoming solar power (such as from the Sun) to create or produce or output a concentrated solar energy (CSE) beam aka a CSE power source. One or more of the optical elements may undergo a calibration during step 516. After completing step 516, the method 500 proceeds to step 520.

At step 520, the set of weld control elements to be used in the welding operation are identified and positioned for use, as controlled by the system controller. The set of weld control elements may include a focal distance actuator, an iris shutter, a weld reflector, and/or a heat sink. After completing step 520, the method 500 proceeds to step 524.

At step 524, any final adjustments of the work piece relative to the weld control elements are performed. Such relative adjustments may involve one or both of the work piece and the set of weld control elements. For example, for the habitation module workpiece of FIG. 6, the habitation module may undergo an orientation change (e.g., such a slight yawing motion) to ensure a welding seam along a particular diameter of the habitation module, and the iris shutter may be adjusted slightly to achieve a particular spot size at a particular location on the (habitation module) welding site. The weld control elements are controlled by the system controller. After completing step 524, the method 500 proceeds to step 528.

At step 528, welding material is fed to the targeted welding site by the weld feeder if required by the welding job, as controlled by the system controller. After completing step 528, the method 500 proceeds to step 532.

At step 532, any agitation of the work piece area to be welded is performed by the agitator. Such agitation may include scraping, scratching, grinding, discoloring, and/or vibrating a surface of the work piece, and/or any other surface preparation operations as known to those skilled in the art. After completing step 532, the method 500 proceeds to step 536.

At step 536, the irradiation zone created by the welding energy beam interacts with the welding material supplied by the weld feeder to produce a weld at the targeted location on the work piece. After completing step 536, the method 500 proceeds to step 540.

At step 540, the relative position of the work piece and the welding site are moved or translated to form a fusion joint. Such relative movement may occur moving one or both of the work piece or the welding site. The welding site location may be moved by operation one or more welding elements, as controlled by the system controller. After completing step 540, the method 500 proceeds to step 544.

At step 544, any adjustment of one or more weld elements may occur, such as adjustment of the iris shutter to ensure a particular spot size. After completing step 544, the method 500 proceeds to step 548.

At step 548, any adjustment to the set of optical elements may occur, so as to ensure a given CSE to the set of welding elements. For example, some of the optical elements may adjust in performing solar tracking to maintain alignment between the sun and concentrator. After completing step 548, the method proceeds to step 552 and the method 500 ends.

As provided above, some steps of the method 500 may be added, deleted, and/or combined. For example, in one embodiment, post welding operations may occur. Such operations may include, for example, non-destructive evaluation of the weld quality (via, e.g., X-ray, acoustic measures, imaging, etc.) may occur, post-process machining such as grinding, addition of colorant, and/or other post welding operations as known to those skilled in the art: post weld heat treatment for stress relief, annealing, or precipitation hardening; mitigation actions to correct welding issues such as remelting and welding; and/or applications of paints, dyes, powders, or coatings. Additionally or alternatively, pre-welding activities may occur to the welding site other than the agitation described, such as preheating of the welding site, adding of colorant, and/or other pre welding operations known to those skilled in the art: positioning and fixturing of the parts to be joined, grinding to improve fit between parts to be joined, grinding to remove oxidation layers or otherwise prepare the surface for welding operations, and/or addition of cleaners to the surfaces to be welded. Also, feed weld material (step 528) may not be required for certain applications.

FIG. 6A depicts a welding system 600 operating on a habitation module work piece 602 detailing a set of optical elements which produce CSE to a set of weld control elements 609. An input light pattern 604, such as provided by the Sun, is received by first optical element 611, a Fresnel lens, and outputs a Fresnel lens light pattern. The Fresnel lens light pattern is in turn received by and reflected from first redirecting mirror 614 to produce first redirecting mirror light pattern. The first redirecting mirror light pattern is received from and reflected from second redirecting mirror 617 to produce second redirecting mirror light pattern. The second redirecting mirror light pattern is the CSE provided to the weld control elements 609. A set of telescoping rods 612, 615, and 613, each fitted with rotational actuators at their terminals, provide positioning of the redirecting mirrors 617, 614, and/or the Fresnel lens 611 by way of system controller (not shown). Telescoping rod 612 connects the first optical element 611 and the first redirecting mirror 614, operating to adjust or set the position and/or orientation of the first optical element 611 and/or the first redirecting mirror 614. Telescoping rod 615 connects the first redirecting mirror 614 and the second redirecting mirror 617, operating to adjust or set the position and/or orientation of the first redirecting mirror 614 and/or the second redirecting mirror 617. Telescoping rod 613 connects the second redirecting mirror 617 and the habitation module work piece 602, operating to adjust or set the position and/or orientation of the second redirecting mirror 617. Note that the optical elements are configured to maintain or deliver a constant incident angle CSE to the weld control elements regardless of Sun and weld position.

The configuration of the optical elements in the welding system 600 embodiment includes two redirecting mirrors between the concentrator and the focal point to give the concentrator access to the entire workpiece while maintaining normal incidence as well as providing precise manipulation of the concentrated hot spot position on the working surface. Precise tilting of the mirrors allows for the use of conventional weaving motions, and the use of two mirrors shortened the focal length, shrank the aperture, lowered the launch mass, and lowered the storage volume required by the system.

In one embodiment, the habitation module work piece 602 is 4.5 m diameter and the first optical element 611 is a Fresnel lens of size about 3 m by 6 m.

The refractive material for the lens may be quartz, which may be the optimal material as determined after evaluating optional materials on the power of the transmitted solar spectrum, required aperture, and material density. Quartz is the lightest option that provides the required solar power. In one embodiment, the refractive material for the lens may be polycarbonate.

In one embodiment of the welding system, a quartz Fresnel lens concentrates solar energy and two redirecting mirrors made of mylar redirect the solar energy to the weld while maintaining a zero incident angle regardless of the weld, solar, or part configuration. The use of two redirecting mirrors minimizes the required focal length, system aperture, and launch mass as a result. Telescoping members work together with rotational actuators to position the mirrors, Fresnel lens, and weld control system while performing a weld and tracking the sun.

In one embodiment of the welding system, the primary solar concentrator 611 is composed of a parabolic reflector which concentrates solar energy and two redirecting mirrors redirect the solar energy to the weld while maintaining a zero angle of incidence regardless of the weld, solar, or part configuration.

FIG. 6B depicts a welding system 601 operating on a habitation module work piece 602′ detailing a set of optical elements which produce CSE to a set of weld control elements 609′. The welding system 601 has similarities to the welding system 600 of FIG. 6A but reverses the optical order of the redirecting mirrors and Fresnel lens, and provides additional detail as to the positioning of the optical elements by way of two telescoping translational actuators and four rotational actuators.

An input light pattern 604, such as provided by the Sun, is received by first optical element 614′, a first reflecting mirror, which reflects the input light pattern to a second optical element 617′, a reflecting mirror, which in turn reflects the input light pattern to a third optical element 611′, a Fresnel lens, which outputs CSE to the weld control elements 609′. The two redirecting mirrors allow the system to weld on surfaces facing away from the sun while also minimizing system mass. The system uses four rotational actuators to maintain alignment between the different optical components and two translational actuators to change the spacing between the redirecting mirrors and/or the Fresnel lens.

A pair of telescoping rods 625, 622 aka booms provide positioning of the redirecting mirrors 617′, 614′, and/or the Fresnel lens 611′ by way of system controller (not shown). Note that the optical elements are configured to maintain or deliver a constant incident angle CSE to the weld control elements regardless of Sun and weld position.

First telescoping rod 625 connects between first optical element 614′ and second optical element 617′, providing a translation motion 625A and thus providing a relative positioning between the first optical element 614′ and second optical element 617′. A first optical element actuator 626 is positioned at a distal end of the first telescoping rod 625 and couples to the first optical element 614′, providing a rotational motion 626A to the first optical element 614′ and thus providing an orientation to the first optical element 614′.

A second optical element actuator 624 is positioned at a proximal end of the first telescoping rod 625 and couples to the second optical element 617′, providing a rotational motion 624A to the second optical element 617′ and thus providing an orientation to the second optical element 617′. Second telescoping rod 622 connects between second optical element 617′ and the third optical element 611′, providing a translation motion 622A and thus providing a relative positioning between the second optical element 617′ and the third optical element 611′.

A third optical element actuator (not shown) associated with the second telescoping rod 622 provides a rotational motion of the second telescoping rod 622 and thus provides a relative rotational positioning between the second optical element 617′ and the third optical element 611′. A fourth actuator (not shown) is positioned at a proximal end of the second telescoping rod 622 and couples to the third optical element 611′, providing a rotational motion 621A to the third optical element 611′ and thus providing an orientation to the third optical element 611′. A set of three optical element legs 629 position the third optical element 611′ relative to the habitation module work piece 602′. In one embodiment, an additional or alternate optical element is composed of an on-axis or off-axis parabolic reflector which outputs CSE to the weld control elements 609. Such an additional or alternate optical element may substitute for the Fresnel lens 611′.

FIG. 6C depicts another welding system 603 operating on a habitation module work piece 602″ detailing a set of optical elements which produce CSE to a set of weld control elements 609″. The welding system 603 has similarities to the welding systems 600 and 601 of respective FIGS. 6A and 6B, but uses only two optical collection/directing components that are maneuvered by two rotational actuators and two translational actuators.

An input light pattern 604, such as provided by the Sun, is received by first optical element 616, a first reflecting mirror, which reflects the input light pattern to a second optical element 619, an offset inflatable parabolic mirror, which outputs CSE to the weld control elements 609″. The offset inflatable parabolic mirror requires gas to maintain shape.

Because the offset parabolic mirror 619 redirects the incoming solar energy in addition to concentrating it, one less redirecting mirror and two less actuators are required. However, the redirecting mirror requires the direction of incoming light and direction to the focal point to be 90 degrees apart to maintain optical alignment. As a result, the inflatable offset parabolic welding system 603 has fewer viable configurations when redirecting light from the sun to the welding target. In addition to fewer actuators, the system 603 uses relatively lighter optical elements and therefore requires less powerful actuators of lighter weight in its motion control system.

A pair of telescoping rods 625′, 622′ aka booms provide positioning of the first optical element 616 and the second optical element 619 by way of system controller (not shown). Note that the optical elements are configured to maintain or deliver a constant incident angle CSE to the weld control elements regardless of Sun and weld position.

First telescoping rod 625′ connects between the first optical element 616 and the second optical element 619. A first telescoping rod translational actuator is coupled to the first telescoping rod 625′ and provides a translation motion 625T to the first telescoping rod 625′ to achieve relative positioning between the first optical element 616 and the second optical element 619. A first telescoping rod rotational actuator is coupled to the first telescoping rod 625′ and provides a rotational motion 625R to the first telescoping rod 625′ to achieve relative angular orientation between the first optical element 616 and the second optical element 619.

Second telescoping rod 622′ connects between the second optical element 619 and the habitation module work piece 602′. A second telescoping rod translational actuator is coupled to the second telescoping rod 622′ and provides a translation motion 622T to the second telescoping rod 622′ to achieve relative positioning between the second optical element 619 and the habitation module work piece 602′. A second telescoping rod rotational actuator is coupled to the second telescoping rod 622′ and provides a rotational motion 622R to the second telescoping rod 622′ to achieve relative angular orientation between the second optical element 619 and the habitation module work piece 602′.

Additional configurations of optical elements are found in other embodiments of the welding system as described in this disclosure.

For example, the SO-WARM optical system may be composed of any of the following configurations of optical elements: 1) a Fresnel lens; 2) a redirecting mirror and a Fresnel lens; 3) two redirecting mirrors and a Fresnel lens; 4) an offset parabolic reflective concentrator; 5) an offset parabolic reflector and one redirecting mirror; or 6) an offset parabolic reflector and two redirecting mirrors. The order of these optical elements of each of these configurations may be varied (e.g. the redirecting mirror can come before or after the Fresnel lens in configuration #2). A secondary solar concentrator such as a reflective compound parabolic concentrator (i.e. SEER, as referenced above) may be used for increased flux density. For configurations 3 and 6, the two redirecting mirrors give the concentrator access to the entire perimeter of large structures like habitats while maintaining normal incidence as well as provide precise manipulation of the concentrated spot position on the working surface. Precise tilting of the mirrors allows for the use of conventional weaving motions, and the use of two mirrors reduces the focal length, aperture, launch mass, and stowage volume required by the system.

In one embodiment of the SO-WARM optical system, a redirecting mirror is positioned first, i.e. to receive solar energy from the Sun, then (in the optical path) a concentrating lens or mirror is positioned, and finally a second redirecting mirror is positioned to provide CSE to the weld control elements of the SO-WARM system.

In one embodiment, a compound parabolic concentrator (CPC) may be utilized in a welding system to serve as a secondary concentrator to increase the optical flux density of a baseline set of optical elements of a welding system that produce or provide CSE. (The baseline optical elements may be deemed a Solar Concentrator Unit (SCU)). The CPC increases the CSE density at the focal point. The CPC uses a parabolic profile tilted to an acceptance angle. The CPC is a non-imaging optic which concentrates solar radiation from multiple directions and is ideal for providing secondary concentration to the light cone produced by the SO-WARM SCU. The CPC may interface with active cooling if needed.

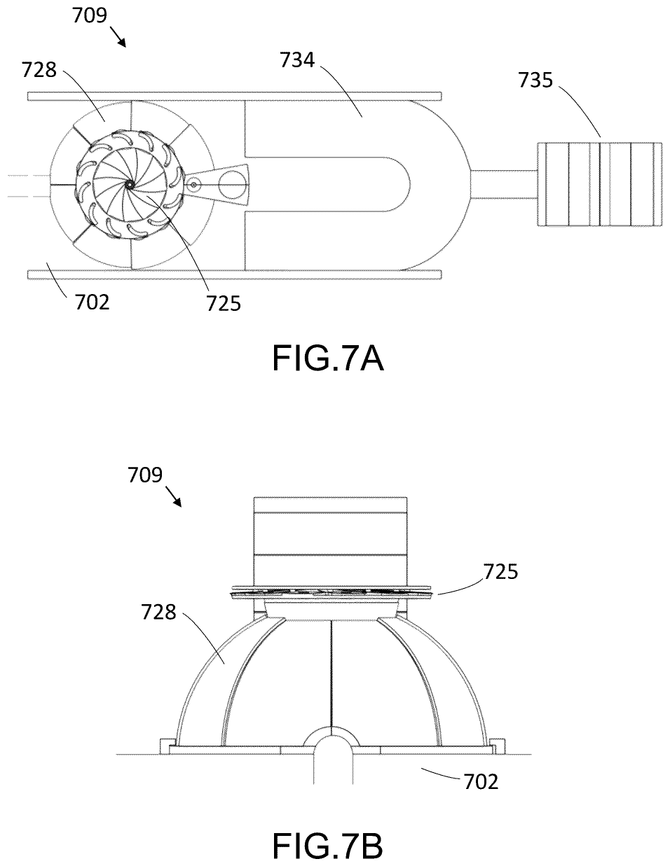

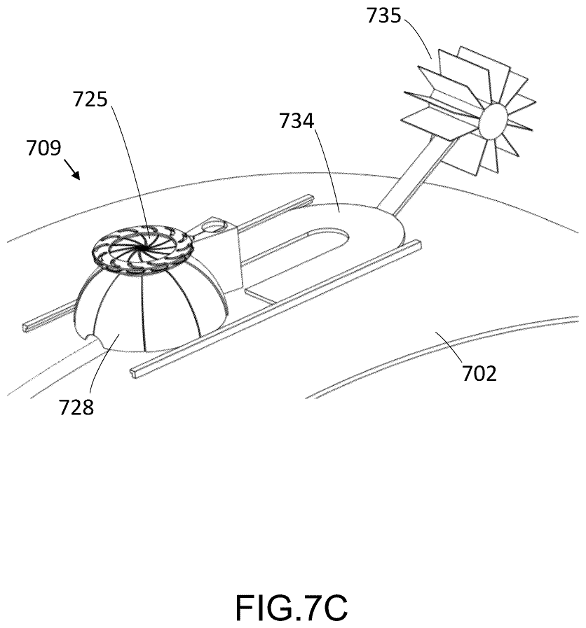

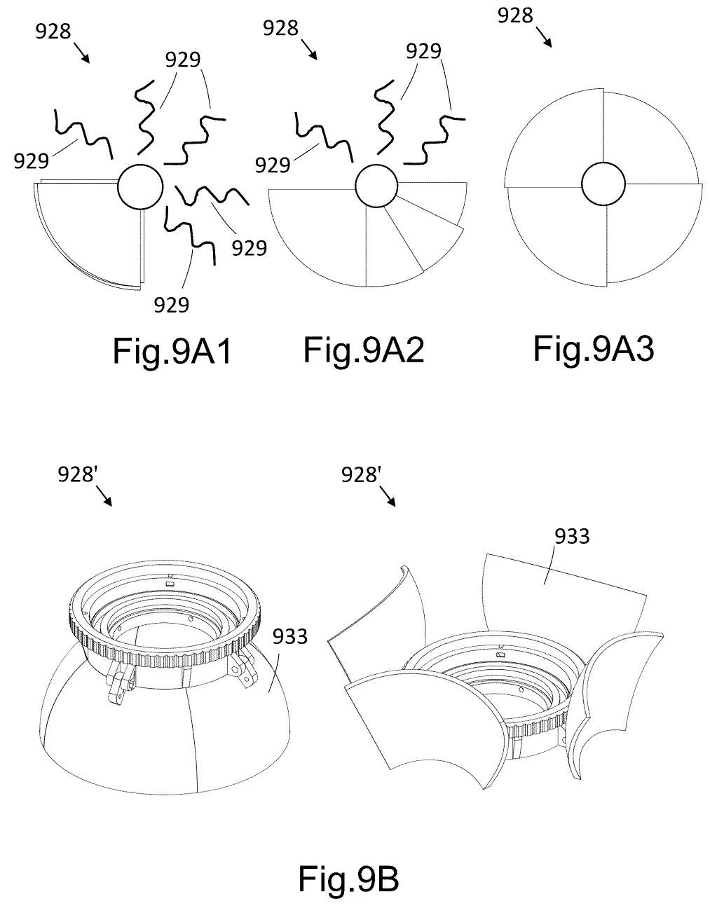

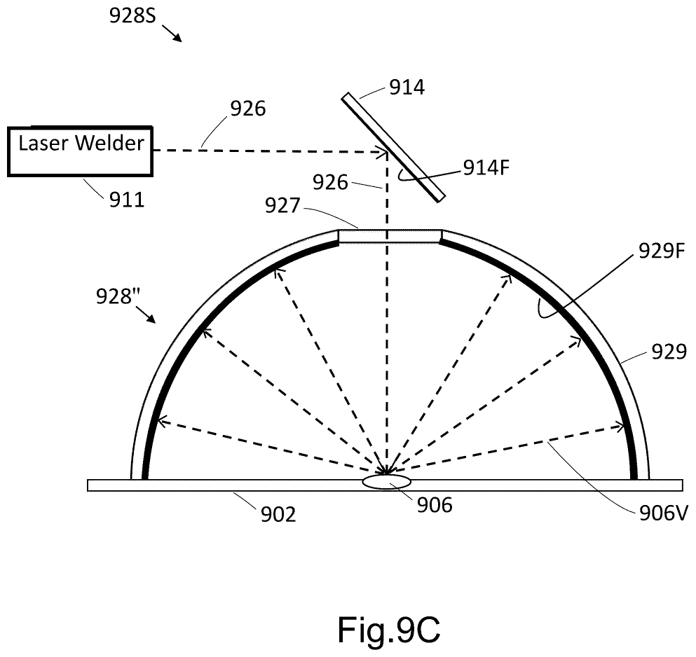

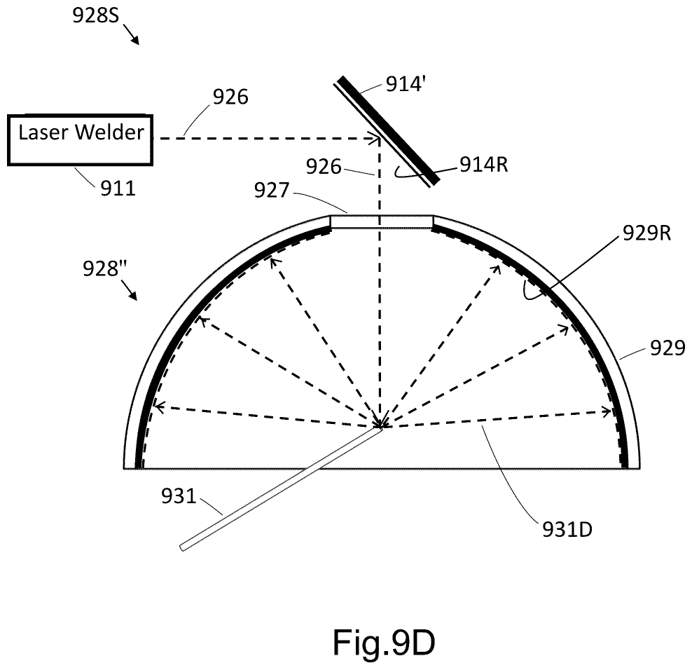

FIGS. 7A-C depict respective top, side, and perspective views of a set of weld control elements 709 of a welding system, namely the iris shutter 725, weld reflector 728, and heat sink 734 as positioned on or adjacent a work piece 702. A CSE aka welding energy beam passes into an interior of the weld reflector 728 (by way of an aperture or void or hole at the top of the weld reflector) and engages with the weld material at the welding site to create an irradiation zone that forms a weld on the work piece. The weld reflector 728 is configured to operate in a vacuum environment, and the irradiation zone forming the weld on the work piece may be deemed a vacuum irradiation zone. The weld reflector 728 surrounds the irradiation zone to reduce and control energy losses of the irradiation zone, the energy losses comprising radiation energy losses and reflection energy losses. The weld reflector 728 forms a dome around the weld site. As shown in FIG. 9A, for example, the weld reflector 928 may be a retractable parabolic weld reflector or a retractable spherical weld reflector, such that it may form a set of selectable states, such states at least of the states of (¾) open, half open, and fully retracted aka fully enclosed, as shown in the sequence of renderings left to right in FIG. 9A. In fully retracted state, the weld site is fully or substantially fully enclosed or encapsulated by or within the weld reflector. Returning to FIGS. 7A-C, the heat sink 734 comprises a U-shaped arm that is positioned near the weld, the U-shaped arm receiving thermal energy e.g. heat from the weld site aka irradiation zone, such thermal energy transferring upwards to the radiator 735 element of the heat sink 734.

FIGS. 8A-B depict respective perspective and side views of a set of weld control elements of a welding system, namely the iris shutter 825, weld reflector 828, and heat sink 834 as positioned on or adjacent a work piece 802, and a grasping end effector 880 (part of a larger multi-axis robot) operating to move and position the combined iris shutter 825 and weld reflector 828. The heat sink 834 comprises a radiator 835 element.

The grasping end effector 880 comprises a proximal end 881 and a distal end 882. The proximal end 881 of the grasping end effector 880 is coupled to or engaged with or attached to the work piece 802 at anchor point 883 by any means known to those skilled in the art, to include, e.g., a ringed clip as shown in FIGS. 8A-B. The distal end 882 of the grasping end effector 880 is coupled to or engaged with or attached to the weld reflector 828 by any means known to those skilled in the art, to include, e.g., via a block extension 884 that connects the distal end 882 of the grasping end effector 880 with the weld reflector 828.

The multi-axis robot may make up most of a system mobility and part manipulation system. A space rated six axis robot allows for various end effectors is attached to the welding platform. An end effector to securely anchor to large stationary structures allows the robot to move the welding platform along the large structures while maintaining proper alignment. A more dexterous end effector, such as that shown in FIGS. 4A and 4B, may be used when welding small structures during which the part is manipulated while the platform is stationary. End effectors described above may be required when welding small components. Incorporating multiple axis allows for the robotic arm to be positioned outside the concentrating light cone while moving the platform or manipulating a work piece.

Cooperation between both the solar concentration and delivery and system mobility and part manipulation systems produces the required weld speed and weld path in one of two modes. During welding of smaller objects where SO-WARM is stationary and the part is manipulated, the robotic arm manipulates the part and produces the required welding speed and path. During welding of large structures, the system mobility and part manipulation system translates the entire welding platform while the work piece remains stationary. The locomotion of the welding platform then produces the welding path.

In one embodiment, all or at least part of the heat sink is a conforming material which, among other things, encourages increased heat transfer. (note: significant thermal conductivity between the heat sink and the work piece in a vacuum is limited).

With attention to FIG. 8C, an air curtain 870 is depicted, as briefly described above with respect to the system 300 of FIG. 3. During welding, vapors evolve from the melt pool. These vapors may then undesirably condense on nearby surfaces. The air curtain 870 implements a nozzle close to sensitive optical elements. Inert gas is flowed through the nozzle into the vacuum environment. (The delivered gas may be called a “sweeping gas”). The gas may then move across the optic as a rarefied gas. Melt pool vapors then have to interact with the inert gas prior to condensing on sensitive optics. Because the nozzle is positioned close to the optic, the rarified gas carries the melt pool vapors away from the optic and limits the opportunity for the melt pool vapers to condense on optical elements and cause fouling.

The air curtain 870 comprises cylindrical portion 871 configured to receive an inert gas supply at inlet 872 and nozzle portion 873. The air curtain 870 prevents fouling of optical components by flowing 874 a rarified gas across optics when operating in vacuum. Stated another way, the nozzle 873 is designed to spread a slow stream 874 of gas across an optic to prevent fouling of that optic by reactive gases.

In one embodiment, air curtain outputs or delivers a gas to prevent fouling of the iris shutter described in welding systems 300 and 400.

FIGS. 9A1, 9A2, and 9A3 depict three operating modes of one embodiment of the weld reflector 928 element of a welding system. The weld reflector 928 may include various retractable components configured to adjustably and selectably set an enclosure level by the weld reflector of the irradiation zone. The weld reflector 928 is a retractable parabolic weld reflector, such that it may form or be set to a set of enclosure states, such states, in one embodiment, of at least the states of (¾ or 75%) open as shown in FIG. 9A1, about half open (½ or 50%) as shown in FIG. 9A2, or fully retracted aka fully enclosed, as shown in FIG. 9A3. Other ranges of selectable settings of the enclosure state are possible. For example, in one embodiment, the enclosure may be set at any level of opening (measured in percentage opening or degrees of opening, wherein a 50% enclosure opening state equates to a 180 degree enclosure opening state, a 75% enclosure opening state equates to a 270 degree enclosure opening state, etc.) between fully enclosed (or 0% enclosure opening state equating to 0 degree enclosure opening state) through to a selectable maximum enclosure opening state, such as for example 90% enclosure opening state. The amount of radiated heat (and/or reflected outward or emitted light) 929 may thus be controlled: a weld reflector that is more open emits or discharges a greater amount of radiated heat 929 and/or light than a weld reflector that is relatively more closed.

Generally, the hemispherical area of the weld reflector 928 (and other embodiments of similar weld reflectors, e.g. weld reflector 928′) may be actively controlled to cause more or less light and/or radiated energy to be reflected back to the weld location. The control of the hemispherical area of the weld reflector 928 may be implemented through petals, leaves, or overlapping sections which may be moved to reflect more or less light.

In a preferred embodiment, the enclosure level of the weld reflector spans full enclosure (or substantially full or 100% enclosure) to no more than 50% enclosure. In a more preferred embodiment, the enclosure level of the weld reflector spans full enclosure (or substantially full or 100% enclosure) to no more than 25% enclosure. In a most preferred embodiment, the enclosure level of the weld reflector spans full enclosure (or substantially full or 100% enclosure) to no more than 20% enclosure. While the thermal control systems limit power input to the workpiece, they cannot control the power leaving the workpiece. The lack of convection in the vacuum of space results in lengthened cooling times that could result in overheating or improper annealing, affecting the weld quality and possibly damaging the workpiece. The detachable radiative heat sink is used for wicking heat away from the area of the weld pool. This heat sink would notionally be composed of a thermally conductive metal such as copper or gold connected to an active heat control device.

Common aerospace materials which may be used for space construction can be highly reflective, such as aluminum. For example, rolled aluminum has reflectance values in the visible spectrum greater than 76% and more than 90% at infrared wavelength. To combat this, the retractable parabolic reflector is used to surround the weld pool to capture and reflect light and radiated heat back onto the weld.

As shown in FIG. 9A, the weld reflector 928 retracts to control how much light and radiated heat is lost to space. The weld reflector is integrated with the iris shutter and mounted to the base of the clamping roller system. Combined, the retractable weld reflector and the radiative heat sink provide bi-directional thermal control over the annealing process to minimize defects and produce strong welds in a variety of conditions in space. The weld reflector has the added benefit of containing any vaporized gases which may be released through the welding process and prevent the contamination of nearby sensors or surfaces.

In another embodiment of the weld reflector 928, an iris is disposed at a top or upper portion of the weld reflector 928. The weld reflector 928 may be a full-curtain design that enables continuous adjustment from 100% coverage of the melt pool to 25% coverage by sequentially rotating each petal. For such an embodiment, the petals are stacked, each with a different radius. A motor is used to rotate the first petal, and sequential rotation of the second and third petals is achieved with pins and slots on either side of a rotating ring on each petal. As the first petal rotates, a slot on its underside slides freely around a pin on the top side of the second petal. Once the first petal has rotated 90°, the end of the slot on the first petal makes contact with the pin on the second petal. Further rotation of the first petal then causes the second petal to also rotate. A similar pin and slot are used to control the motion between the second and third petals. The fourth petal remains stationary during all actuations. The use of the recessed path and stud on the second and third petal allows for sequential operation of each petal when adjusting the amount of reflective surface to expose to the melt pool.

FIG. 9B depicts another embodiment of the weld reflector 928′ element of a welding system. In the weld reflector 928′ design, each of the reflective petals are articulated sequentially to control the amount of radiated and reflected energy loss in 25% increments between nearly 0% and 100%. FIG. 9B shows the weld reflector fully closed and fully open. Two mechanisms for articulating the reflector petals may be used: a cam-based and a gear-based system. In the cam-based system, a ring is rotated by a stepper motor. As the ring rotates, a cut out acts as a cam surface and engages a follower. Each petal has one follower. As the follower is translated by the rotating ring, it pulls on a wire which in turn pulls on the petal causing it to rise. FIG. 9B (left) shows the grooves for the follower of each petal on the upper most surface of the assembly. Not shown are the actual followers nor the rotation cam ring. The gear-based system also uses a rotation ring, but the system uses gears instead of a cam and follower. The rotating ring has gear teeth on one quarter of its circumference. Each petal then has a spur gear which interfaces with a rotating ring. As the rotating ring engages the gear for one of the petals, it causes the first gear to rotate and rotates a bevel gear which in turn rotates the applicable petal up or down. The changing length of thread then articulates the petal.

In another embodiment of the weld reflector element of a welding system, the weld reflector also includes a black body dome.

The black body dome allows the weld reflector to further function as a heat sink. The weld reflector comprises an outer hemispherical black body dome surrounding the reflective petals of the baseline weld reflector. As the petals retract, the petals expose the weld to the black body dome such that radiative heat transfer is increased, thereby cooling the weld site. The hemispherical black body dome may be connected to a cooling system (e.g., a radiator and a heat transfer system) to facilitate heat dissipation. The weld reflector therefore enables a controllable range of reflectivity of the hemisphere surrounding the weld site through the opening and closing of the reflective petals, enabling a range from approximately 0 to 1 of reflectivity of the hemisphere to which the weld site has a viewing angle. Furthermore, this weld reflector with black body dome embodiment has the added benefit of always maintaining a nearly fully enclosed hemispherical surface surrounding the weld site to contain any vapors produced at the weld site and to prevent such vapors from collecting on nearby sensors or hardware, and making operation safer if there are astronauts nearby both due to the reduced eye hazard and reduced hazard from high temperature metallic vapors.

In some configurations of the weld control elements, namely of the iris and the various weld reflector embodiments, the iris is not disposed at an upper portion of the weld reflector, but instead is more generally positioned optically upstream of the weld reflector, such as at or adjacent an upper portion of the black body dome embodiment or at or adjacent the upper portion of the weld reflector.

In one embodiment of the welding system, an output nozzle is positioned near the weld location, the output nozzle emitting a shield gas to or near the weld location, the shield gas operating to, among other things, protect system elements at or near the weld location, such as optics or sensors, from undesirable effects of any off gassing from the weld location. (Such undesirable effects may include, e.g., deposits on optics or sensors that harm or possibly disable functionality of the optic or sensor). Such an output nozzle may be configured as the air curtain described above with respect to FIG. 8C.

FIGS. 9C and 9D depict operating characteristics of a weld reflector system 928S of a welding system, the weld reflector system 928S operating in a first mode and a second mode, respectively. In FIG. 9C, the weld reflector system 928S is depicted operating in a laser protection mode (a first mode) with a mirror 914. In FIG. 9D, the weld reflector system 928S is depicted operating in a laser-based vapor deposition (LVD) mode (a second mode) with a mirror 914′. The weld reflector system 928S in the first mode of FIG. 9C operates to mitigate optical fouling in laser welding processes caused by spatter and vapor deposition. The mirrors, aka redirecting mirrors, 914 and 914′ may be a rigidly fixed mirror or a beam-steering mirror. In one embodiment, the mirrors 914 and 914′ are the same mirror and are simply operating in the two described weld reflector system 928S modes. In one embodiment, the mirrors 914 and 914′ are not the same mirror and instead are different mirrors.

The weld reflector 928″ works in tandem with a beam-steering mirror (mirror 914 in FIG. 9C operating in the first mode, and mirror 914′ in FIG. 9D operating in the second mode) that redirects a laser beam 926 from the laser welder 911 to the welding bead 906 or welding surface, enabling the welder to be positioned off-axis to the weld surface and eliminating any direct pathway for vaporized material to reach the laser welder optics. In order to maximize efficiency and service life of the dome of the weld reflector 928″ and the beam-steering mirror, the weld reflector system 928S utilizes the same vapor deposition process that causes fouling to periodically reapply reflective coatings to these normally sacrificial components. Fouling is automatically detected on the reflective surfaces using in situ reflectometry and a fresh layer of reflective metal is systematically deposited by intentionally vaporizing a source material 931 in a precisely controlled manner. Laser-based Vapor Deposition (LVD) techniques are commonly used in industry for applying thin-film metallic coatings and can be adapted to work with any typical high-power (e.g., 1-2 kW) laser welding system, enabling dual-use for welding and vapor deposition. For a Continuous Wave (CW) laser welding system, vapor is generated by melting and evaporating the metal source material completely. For a pulsed wave laser welding system, the top surface of the source material is ablated in a precisely controlled fashion to produce vapor following a more conventional, Pulsed Laser Deposition (PLD) process.

By surrounding the active welding area with a simple yet robust enclosure (the weld reflector 928″), hazardous fumes, airborne particulates, and metal spatter are confined, thereby maintaining a clean environment for precise beam delivery and weldability. A stable thermal environment surrounding the weld pool leads to enhanced process reliability, higher weld quality, and more consistent penetration characteristics.

The implementation of a beam-steering mirror 914 in system 928S when operating in the first mode enables the weld reflector 928″ dome to protect welding optics by altering the beam's path away from the laser's optics or other nearby components or systems. The redirecting mirror 914 may be mechanically coupled with the dome to ensure that it consistently maintains the correct orientation relative to the weld surface. This coupling allows the mirror to dynamically adjust as needed, ensuring optimal beam delivery and efficient energy transmission during welding operations. The mirror 914 may be used to switch between the welding surface and the source material rather than moving the assembly or the source material, providing an efficient way to initialize the replating process. Additionally, the actuated mirror may incorporate thermal management features such as thermocouples to monitor localized heat buildup or contamination on the mirror surface. When fouling is detected, the system may dynamically shift the reflective zone to an unused portion of the mirror while maintaining precise beam alignment. This approach extends operational longevity during extended welding runs and preserves a high-quality reflective surface for the re-plating process.

Both the weld reflector 928″ dome and mirrors (e.g., 914, 914′) are designed for seamless integration into a robotic laser welder. These components attach directly to the welder's optical system via a mechanical linkage, ensuring stability, accuracy, and repeatability in operation. This integration allows for real-time adjustments, maintaining proper alignment and maximizing weld quality.

In one embodiment, the source material 931 when the system 928S is operating in the second mode notionally consists of a thin aluminum wire, and may utilize welding filler wire. In some embodiments, alternative materials such as silver or gold are utilized for specialized plating applications. The source material 931 may be of different source geometries, such as plates or spheres. For a flat plate configuration, the deposition source may simply be positioned near the weld region, and the actuated redirecting mirror may be employed to dynamically reroute the laser beam from the weld surface to the plate as needed. Given that the vapor plume is ejected perpendicular to the surface, an alternative plating method for the weld reflector 928″ dome may involve tilting the source plate and rotating the dome around it, ensuring an even coating on the interior. In contrast, when small spheres or pellets serve as the source material, a robotic arm equipped with a precise feeding mechanism may deposit the pellets into the beam path for complete evaporation. This method yields a clean, byproduct-free process, as each pellet is fully consumed during laser exposure. Notionally, the shape of the source material for wire and sphere/pellet geometries when melted is spherical and metal vapors are ejected radially outwards, enabling both the weld reflector 928″ dome and mirror 914′ to be re-coated without actuating the source material or components.

In one embodiment, a spectroscopic ellipsometer is the primary monitoring tool. This sensor is responsible for film thickness measurement, refractive index calibration, stoichiometry and composition analysis, and/or deposition rate control. The ability of a spectroscopic ellipsometer to perform both in-situ and ex-situ monitoring makes it ideal for real-time process control and characterization of thin film deposition. The spectroscopic ellipsometer may be mounted directly onto the deposition system, through an optical port, allowing real-time measurement without interrupting the process using specialized software and CCD cameras.

In one embodiment, integrated photodiode arrays and/or cameras for reflectance monitoring and pyrometers for real-time substrate and deposition-source temperature measurement may be utilized. These compact and radiation-hardened sensors, while not as comprehensive as ellipsometry, still provide essential real-time feedback on coating uniformity and thermal stability, enabling adaptive control of the deposition process in space.

The weld reflector system 928S comprises a laser welder 911 that emits laser beam 926, a beam-steering mirror (identified as 914 when the system 928S is operating in the first mode, and as 914′ when the system 928S is operating in the second mode) that reflects and steers the laser beam 926, and a weld reflector 928″ comprising a hazard isolation dome 929. The weld reflector 928″ receives the reflected laser beam 926 through dome aperture 927. The reflective hazard isolation dome 929 surrounding the weld bead 906 or seam serves as a physical barrier between sensitive laser welding optics and vaporized metal particulates created during the welding process.

During welding operations, as depicted in FIG. 9C and termed a first mode of operation aka laser protection mode, the laser beam 926 is directed by mirror 914 to the weld bead 906 on weld plate 902, resulting in metal vapor 906V directed away from the weld beam 906 and toward an inner surface of the hazard isolation dome 929. The metal vapor 906V deposits and fouls the beam-steering mirror (by passing through the dome aperture 927) and the inner surface of the hazard isolation dome 929, resulting in respective fouled mirror surface 914F and fouled dome surface 929F.

During laser-based vapor deposition operations, as depicted in FIG. 9D and termed a second mode of operation, the laser beam 926 is again directed into the hazard isolation dome 929 (by mirror 914′) through the dome aperture 927 but engages source material 931 to create replating deposit vapor 931D. The replating deposit vapor 931D is deposited on the beam-steering mirror 914′ (by passing through the dome aperture 927) and the inner surface of the hazard isolation dome 929, resulting in respective replated mirror surface 914R and replated dome surface 929R.

FIG. 10A depicts a welding system 1000 operating on a welding site 1006 of a habitation module work piece 1002. The system 1000 comprises a baseline optical power source 1005 that provides a baseline light pattern 1004 to a first optical element 1011, a Fresnel lens, and outputs a Fresnel lens light pattern to a redirecting mirror 1014 to produce a redirecting mirror light pattern (a CSE) directed to welding control elements (not shown) of a welding site 1006. The set of two optical elements are positioned by a pair of translational rods 1013 and 1015, the rods controlled by system controller (not shown). Translation rod 1015 enables translation 1015T between the first optical element 1011 and the redirecting mirror 1014. Translation rod 1013 enables translation 1013T of the redirecting mirror 1014 to provide positioning and/or orientation of the redirecting mirror light pattern (CSE) reflected by the redirecting mirror 1014 to the welding control elements. Redirecting mirror 1014 may rotate as 1014R by an actuator (not shown). Translational rod 1013 may engage an end effector assembly 1080, the end effector assembly 1080 engaged with one or more welding control elements to enable positioning and movement of one or more welding control elements relative to the welding site 1006.

FIG. 10B depicts a welding system 1090 operating on a welding site 1006′ of a work piece 1002′, The system 1090 comprises a baseline optical power source 1005 that provides a baseline light pattern 1004 to a first optical element 1011, a Fresnel lens, and outputs a Fresnel lens light pattern to a redirecting mirror 1014 to produce a redirecting mirror light pattern (a CSE) directed to welding control elements of a welding site 1006′ of the welding work piece 1002′. The set of two optical elements are positioned by a pair of translational telescoping rods 1013′ and 1015′, the rods controlled by system controller (not shown). The telescoping rod 1013′ engages with an end effector assembly 1080′ comprising clamping arms and clamping rollers (similar to the clamping arms 482 and clamping rollers 484 of system 400 described above).

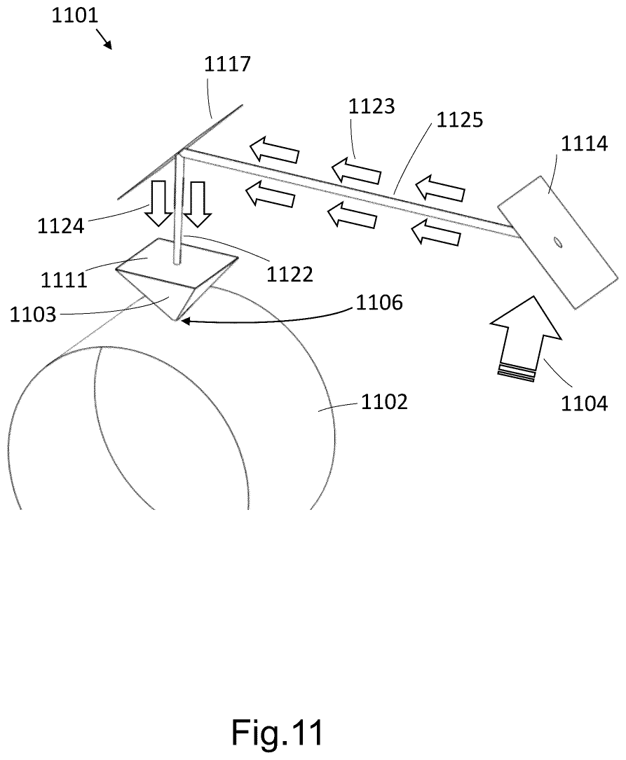

FIG. 11 depicts another embodiment of a welding system 1101 operating on a habitation module work piece 1102. The welding system 1101 is generally similar to the welding system 601 of FIG. 6B but presents details of the light beams of the optical components. A Fresnel lens 1111 concentrates solar energy, the solar energy redirected by two mirrors 1114 and 1117. The system 1100 maintains a constant incident angle regardless of sun and weld position. Note that the entire welding system 1100 may move around the work piece (here, a habitation module work piece 1102) for surface operations on large modules or habitats, or remain stationary while manipulating smaller workpieces, such as structural members.

The welding system 1101 comprises a set of optical elements which produce CSE 1103 to a set of weld control elements (not shown). An input light pattern 1104, such as provided by the Sun, is received by first optical element 1114, a first reflecting mirror, which reflects its received input light pattern 1104 as an output light pattern 1123 to a second optical element 1117, a reflecting mirror, which in turn reflects its received input light pattern 1123 as output light pattern 1124 to a third optical element 1111, a Fresnel lens, which receives the light pattern 1124 and outputs CSE 1103 to the weld control elements and weld a welding site 1106. The two redirecting mirrors 1114 and 1117 allow the system 1101 to weld on surfaces facing away from the sun while also minimizing system mass. The pair of telescoping rods 1125 and 1122 aka booms provide positioning of the redirecting mirrors 1114 and 1117 and/or the Fresnel lens 1111 by way of system controller (not shown). Note that the optical elements are configured to maintain or deliver a constant incident angle CSE to the weld control elements regardless of Sun and weld position.

First telescoping rod 1125 connects between first optical element 1114 and second optical element 1117, providing a translation motion and thus providing a relative positioning between the first optical element 1114 and second optical element 1117.

Second telescoping rod 1122 connects between second optical element 1117 and the third optical element 1111, providing a translation motion and thus providing a relative positioning between the second optical element 1117 and the third optical element 1111. Additional rotational actuators may be fitted to the welding system 1101 to orient one or more of the first optical element 1114, the second optical element 1117, and the third optical element 1111.

Six different solar concentrator concepts consisting of two different redirecting mirror configurations and three different solar concentrators may be considered in different embodiments of a welding system. Redirecting mirrors are required for each system, and single and double redirecting mirror systems are considered for each of the concentrators. Three different concentrators may be defined as follows: inflatable offset parabolic concentrator, rigid offset parabolic concentrator, and refractive concentrator.

Each system is designed to form a fusion joint around the circumference of a 4.5 m diameter habitat module. An evaluation assumed both the habitat module and solar source would remain stationary during the weld, and the flux density required to produce a fusion joint was assumed to be 10 W/mm². Designing the systems in this way addressed issues of shadowing along the back side of large components during the most limiting case. To ensure each system was able to produce the required fusion joint, three different limiting cases were identified pertinent to the following systems:
Systems with two redirecting mirrors: 10 W/mm² peak flux with an incident angle of 0°
Offset parabolic concentrators with one redirecting mirror: 10 W/mm² peak flux with an incident angle of 45°
Refractive concentrator with one redirecting mirror: 10 W/mm² peak flux at the back of the habitat module

Each concept was modeled using a Monte-Carlo raytracing software with applicable slope errors and solar reflectivity. The system was then iterated until the smallest possible aperture and shortest possible focal length which meets the above requirements were identified. The systems were then modeled to investigate stowage volume and launch mass.

Various embodiments of the disclosed welding system may include or be described by the following features:
A solar concentrator system composed of a refractive or reflective solar concentrating optic, optional redirecting mirrors before or after the solar concentrating optic, and optional secondary concentrator at the weld location.
Inclusion of any combination of the following: grasping end effector for traversing a structure or manipulating a part, an adjustable weld reflector, a mechanical iris, an adjustable heat sink, and/or a non-contact temperature sensor.
a solar welding system that translates around a stationary object to produce a fusion joint
a solar welding system which remains stationary while manipulating a part to produce a fusion joint
a solar welding system that translates while also manipulating a part to produce a fusion joint
A solar concentrator system which tracks the sun and maintains alignment of two or more optical elements to direct and concentrate the solar energy to a defined location (there is prior art in the form of U.S. Pat. No. 11,162,713 “Light Concentrator System for Precision Thermal Processes”).
A process monitoring system which monitors the temperature, size and shape of the melt pool generated and the heat affected zone.

A weld reflector which limits the energy loss from the welding process by adjusting the area of the weld which is exposed to open space
A passive heat sink which conducts heat from the weld and dissipates heat via a radiator to limit the temperature rise of the workpiece and provide additional temperature control by adjusting the position of the heat sink relative to the weld
A mechanical iris to control the solar energy into the irradiation zone and size of the melt pool by adjusting the size of the transmitted spot
A focal position actuator to control the energy density of the CSE delivered to the weld by controlling the distance between the working surface and the primary concentrator
Control system which actuates a weld reflector, iris, and heat sink to maintain a desired melt pool temperature, size, and shape.

In one embodiment of the welding system, one or more sacrificial windows are employed to prevent fouling on nearby equipment or optics when there is a direct line of sight from the melt pool to the equipment or optics. This protection may be thin fused silica plates, rolled (transparent) films, filter wheels, or through implementation of a redirecting mirror (see e.g., FIGS. 9C-D above).

In one embodiment of the welding system, a sweeping gas may alternatively be used for reducing fouling of windows. Such an embodiment works especially well when the weld reflector is a totally enclosed volume in intimate contact with the workpiece and has a window at its inlet. The sweeping gas may be recovered if needed. A sweeping gas may also be used in vacuum. In some embodiments, the sweeping gas may be recovered in a non-enclosed weld chamber by way of a cryotrap. For example, having the gas exit the sweeping gas nozzle, travel in a path between the workpiece and sensitive optics, and then recovered using a cryotrap. Alternatively, a plasma (charged gas) may be implemented and then recovered via a magnetic separation means. If ionization occurs for the material that is ejected from the melt pool, then magnetic fields may be used to direct this charged plasma away from sensitive optics to prevent fouling.

Note that other methods of use of the disclosed welding system are possible. For example, as a non-limiting example, the above embodiments and features may be applied for use with electron beam welding (in addition to laser welding). Also, any of the steps, functions, and operations discussed herein can be performed continuously and automatically. In some embodiments, one or more of the steps of the method of use may comprise computer control, use of computer processors, and/or some level of automation.

The exemplary systems and methods of this disclosure have been described in relation to systems and methods involving a space-based solar-powered welding system. However, to avoid unnecessarily obscuring the present disclosure, the preceding description omits a number of known structures and devices, and other application and embodiments. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

A number of variations and modifications of the disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A welding system comprising:
a set of optical elements configured to receive an input light pattern and provide concentrated solar energy (CSE);
a set of weld control elements configured to receive the CSE and provide a welding energy beam, the set of weld control elements comprising a focal distance actuator, an iris shutter, and a weld reflector;
a weld feeder configured to deliver weld material to a welding site on a work piece;
a work piece end effector configured to position the work piece relative to the welding site; and
a system controller configured to control a set of welding parameters of the welding energy beam and to control a relative position of the work piece and the welding site by way of the work piece end effector;
wherein:
the focal distance actuator receives the CSE and provides a first energy beam of a selectable energy density controlled by the system controller;
the iris shutter receives the first energy beam and produces the welding energy beam having a selectable spot size controlled by the system controller;
the welding energy beam passes into an interior of the weld reflector and engages with the weld material at the welding site to create an irradiation zone that forms a weld on the work piece; and
the weld reflector at least partially encloses the irradiation zone to reduce energy losses of the irradiation zone, the energy losses comprising at least one of radiation energy losses and reflection energy losses.

2. The system of claim 1, wherein the set of optical elements include at least one of a parabolic reflector and a Fresnel lens, and at least two reflecting mirrors.

3. The system of claim 1, wherein the set of weld control elements further comprise a heat sink configured to conduct heat away from the work piece.

4. The system of claim 1, wherein the set of weld control elements further comprise a mechanical agitator configured to perform at least one of scraping, scratching, grinding, discoloring, and vibrating a surface of the work piece.

5. The system of claim 1, wherein the set of welding parameters comprise weld temperature, weld spot size, radiative heat loss, conductive heat loss, and heat affected zone size.

6. The system of claim 1, wherein: the system is configured to operate in a vacuum environment, and the irradiation zone forming the weld on the work piece is a vacuum irradiation zone.

7. The system of claim 1, wherein the weld reflector comprises a retractable component configured to adjustably set an enclosure level by the weld reflector of the irradiation zone.

8. The system of claim 7, wherein the weld reflector is of hemispherical shape and the enclosure level is selectable between a full enclosure state and a set of partially enclosed states.

9. The system of claim 1, further comprising a set of sensors configured to identify a work piece phase change, the work piece phase change used by the controller to control the set of weld parameters.

10. The system of claim 1, further comprising an air curtain device configured to deliver a sweeping gas adjacent to the iris shutter to reduce fouling of the iris shutter.

11. A method of using a welding system comprising:
providing a welding system comprising:
a set of optical elements configured to receive an input light pattern and provide concentrated solar energy (CSE);
a set of weld control elements comprising a focal distance actuator, an iris shutter, and a weld reflector;
a weld feeder configured to deliver weld material to a welding site on a work piece;
a work piece end effector configured to position the work piece relative to the welding site; and
a system controller configured to control a set of welding parameters of the welding beam and to control a relative position of the work piece and the welding site by way of the work piece end effector;
positioning the work piece in preparation for receiving a weld;
positioning the focal distance actuator to receive the CSE and provide a first energy beam of a selectable energy density;
positioning the iris shutter to receive the first energy beam and provide a welding energy beam having a selectable spot size;
passing the welding energy beam into an interior of the weld reflector and engaging with the weld material at the welding site to create an irradiation zone that forms the weld on the work piece; and
adjustably enclosing the irradiation zone with the weld reflector to reduce energy losses of the irradiation zone, the energy losses comprising at least one of radiation energy losses and reflection energy losses.

12. The method of claim 11, wherein the set of optical elements include a Fresnel lens and at least two reflecting mirrors.

13. The method of claim 11, wherein the set of weld control elements further comprise a heat sink configured to conduct heat away from the work piece.

14. The method of claim 11, wherein the set of weld control elements further comprise a mechanical agitator configured to perform at least one of scraping, scratching, grinding, discoloring, and vibrating a surface of the work piece.

15. The method of claim 11, wherein the set of welding parameters comprise weld temperature, weld spot size, radiative heat loss, conductive heat loss, and heat affected zone size.

16. The method of claim 11, wherein: the system is configured to operate in a vacuum environment, and the irradiation zone forming the weld on the work piece is a vacuum irradiation zone.

17. The method of claim 11, wherein the set of optical elements include at least one of a parabolic reflector and a Fresnel lens, and at least two additional reflecting mirrors.

18. The method of claim 11, wherein the weld reflector comprises a retractable component configured to adjustably set an enclosure level by the weld reflector of the irradiation zone.

19. A welding system comprising:
a set of optical elements configured to receive an input light pattern and provide concentrated solar energy (CSE);
a set of weld control elements configured to receive the CSE and provide a welding energy beam, the set of weld control elements comprising a focal distance actuator, an iris shutter, and a weld reflector comprising a retractable component;
a weld feeder configured to deliver weld material to a welding site on a work piece;
a work piece end effector configured to position the work piece relative to the welding site;
a set of sensors configured to identify any work piece phase change; and
a system controller configured to control a set of welding parameters of the welding energy beam and to control a relative position of the work piece and the welding site by way of the work piece end effector;
wherein:
the focal distance actuator receives the CSE and provides a first energy beam of a selectable energy density controlled by the system controller;
the iris shutter receives the first energy beam and produces the welding energy beam having a selectable spot size controlled by the system controller;
the welding energy beam passes into an interior of the weld reflector and engages with the weld material at the welding site to create an irradiation zone that forms a weld on the work piece;
the retractable component adjustably sets an enclosure level by the weld reflector of the irradiation zone to reduce energy losses of the irradiation zone, the energy losses comprising at least one of radiation energy losses and reflection energy losses;
any identified work piece phase change is used by the controller to control the set of weld parameters; and
the set of welding parameters comprise at least two of weld temperature, weld spot size, radiative heat loss, conductive heat loss, and heat affected zone size.

20. The welding system of claim 19, wherein the weld reflector is of hemispherical shape and the enclosure level is selectable between a full enclosure state and a set of partially enclosed states.
